(19) United States
(12) Patent Application Publication
(10) Pub. No.: US 2006/0073059 A1
(43) Pub. Date: Apr. 6, 2006

(54) Poly-inductive machines and differential turbines

(76) Inventor: Normand Beaudoin, St-Hippolyte (CA)

Correspondence Address: CONNOLLY BOVE LODGE & HUTZ LLP, SUITE 800, 1990 M STREET NW, WASHINGTON, DC, 20036-3425, US

(21) Appl. No.: 11/282,732

(22) Filed: Nov. 21, 2005

Related U.S. Application Data
(63) Continuation of application No. 10/471,427, filed on Feb. 12, 2004.

(30) Foreign Application Priority Data
Mar. 15, 2001 (CA) 2,340,950
Mar. 16, 2001 (CA) 2,340,954
Mar. 22, 2001 (CA) 2,342,438
Mar. 22, 2001 (CA) 2,341,801
Mar. 22, 2001 (CA) 2,341,798
Mar. 22, 2001 (CA) 2,342,442

(51) Int. Cl. F01C 1/02; F16N 13/20; F01C 1/063; F04C 2/00

(52) U.S. Cl. 418/61.2

(57) ABSTRACT

A poly-inductive rotative machine comprising a compressive member, wherein induction of the compressive member is achieved by a mechanism realizing a positive induction on both a front and a back surface thereof, this mechanism being selected in the group consisting of a semi-transmission, a double semi-transmission, a side transmission, a pivot gear assembly, a poly-induction cam assembly, a poly-induction connecting rod assembly and a poly-induction sliding coupling assembly.

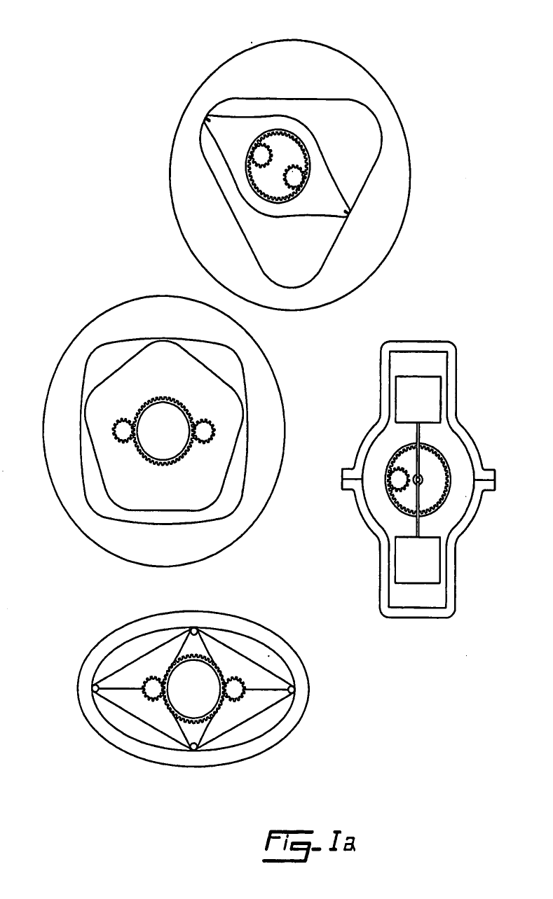

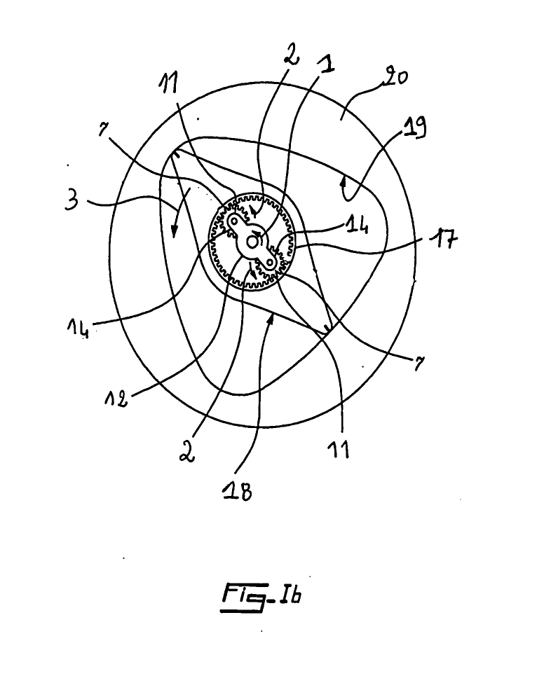

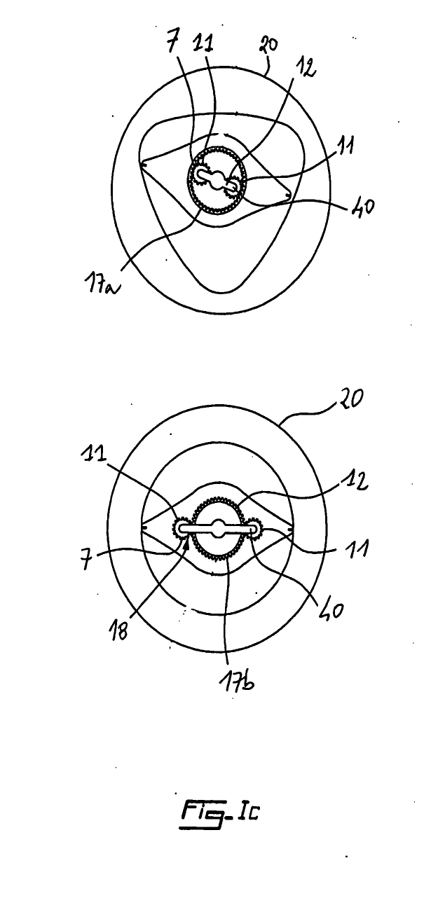

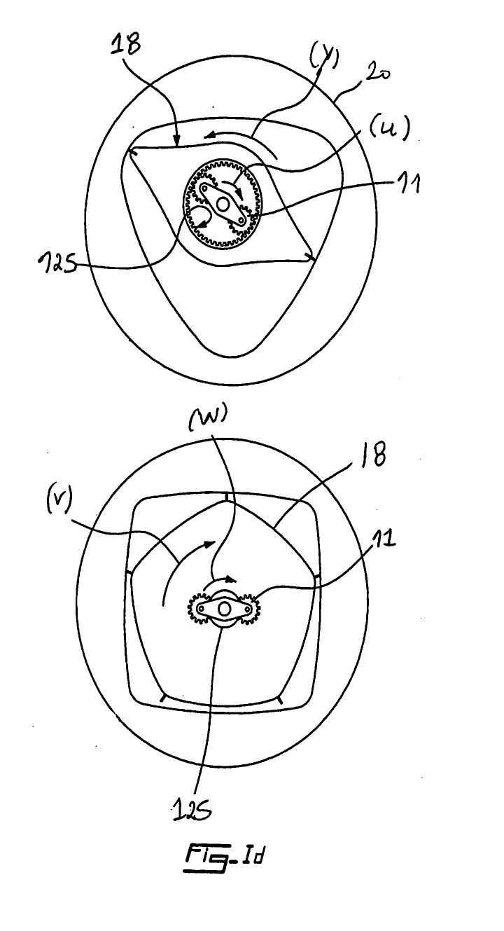

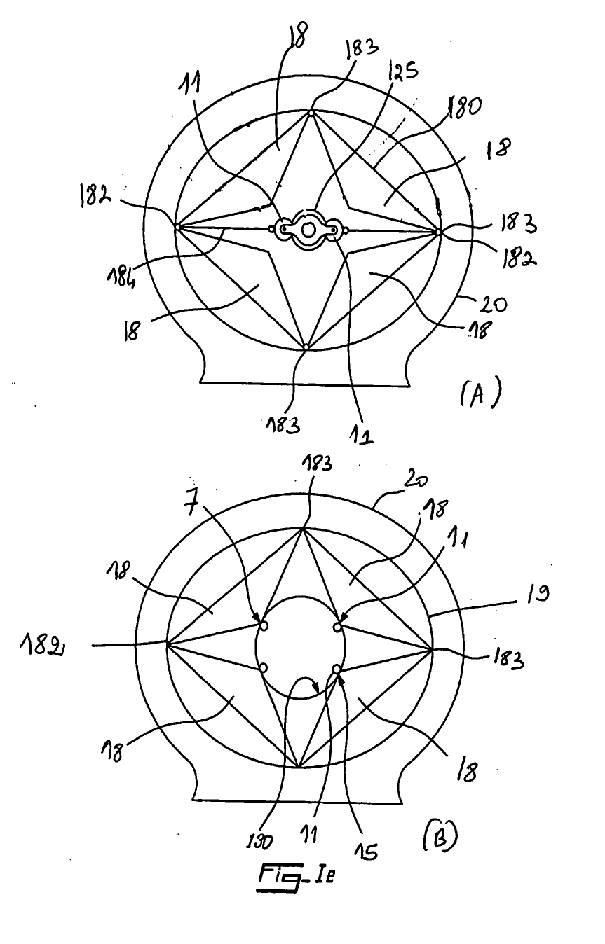

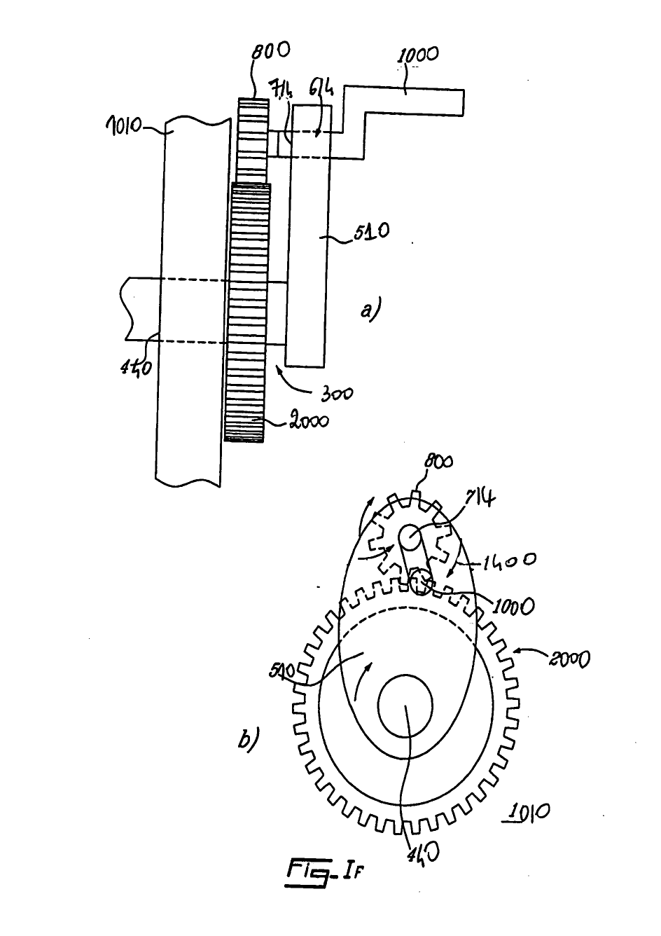

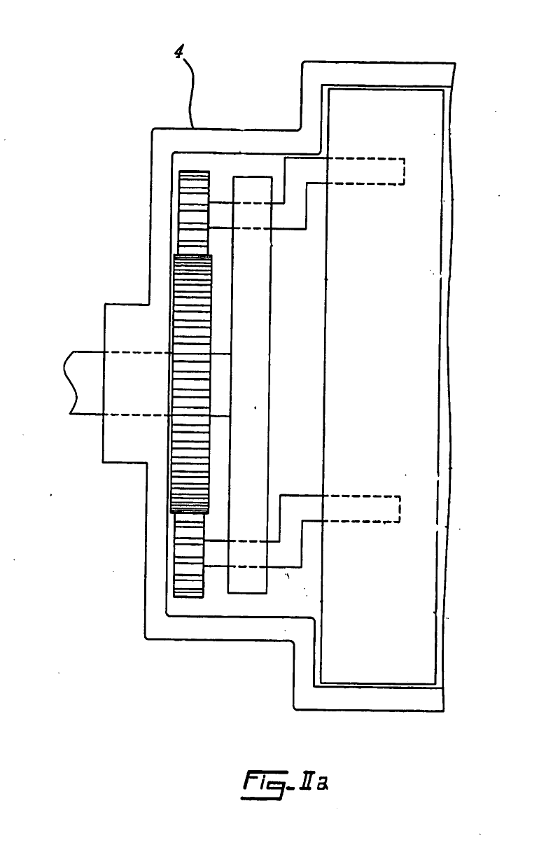

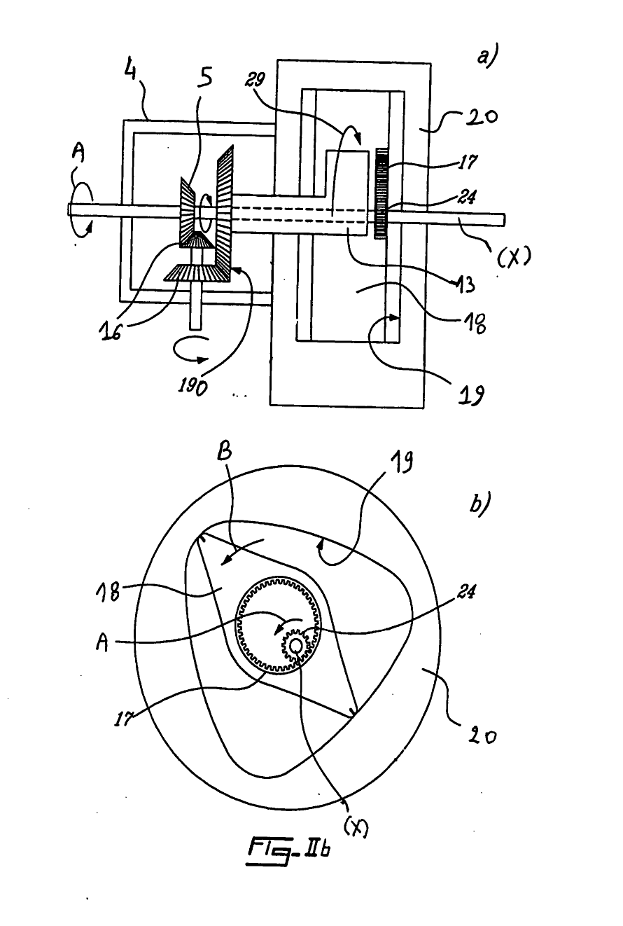

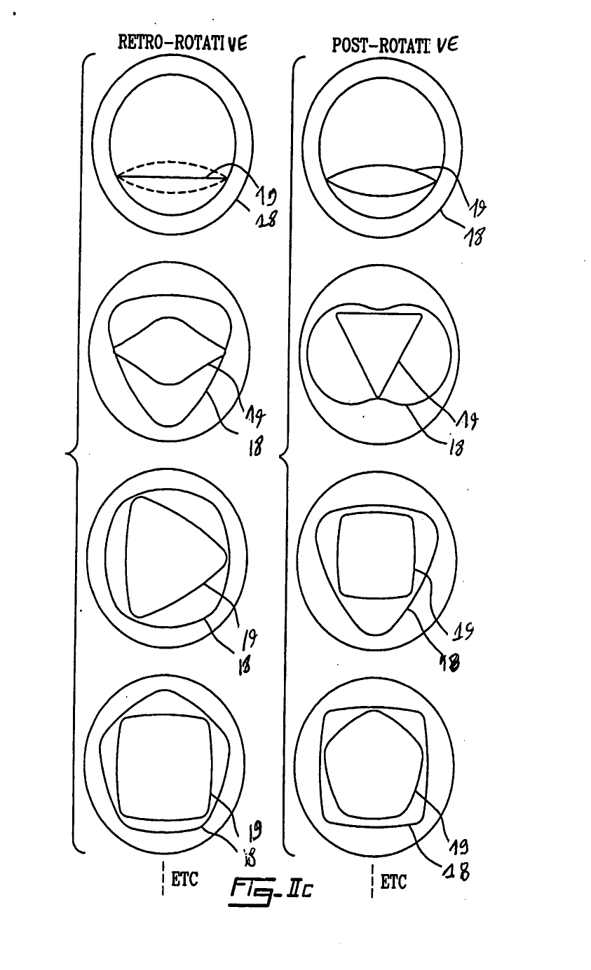

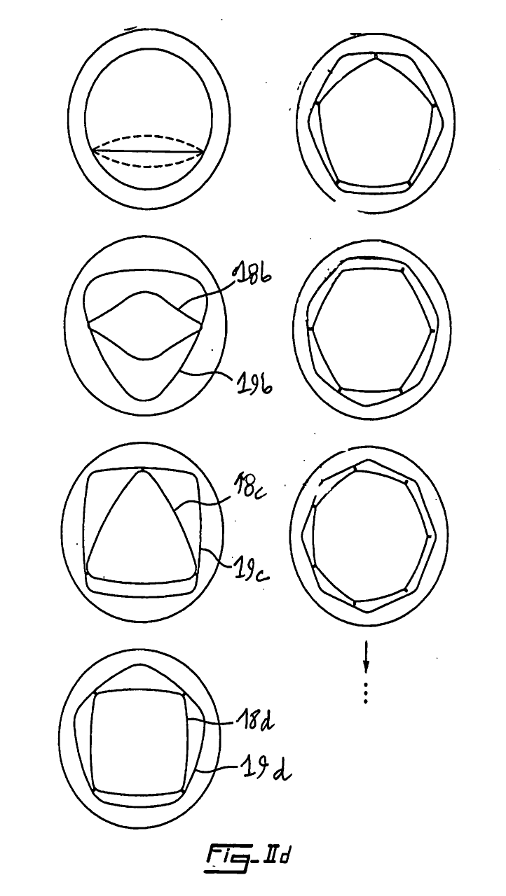

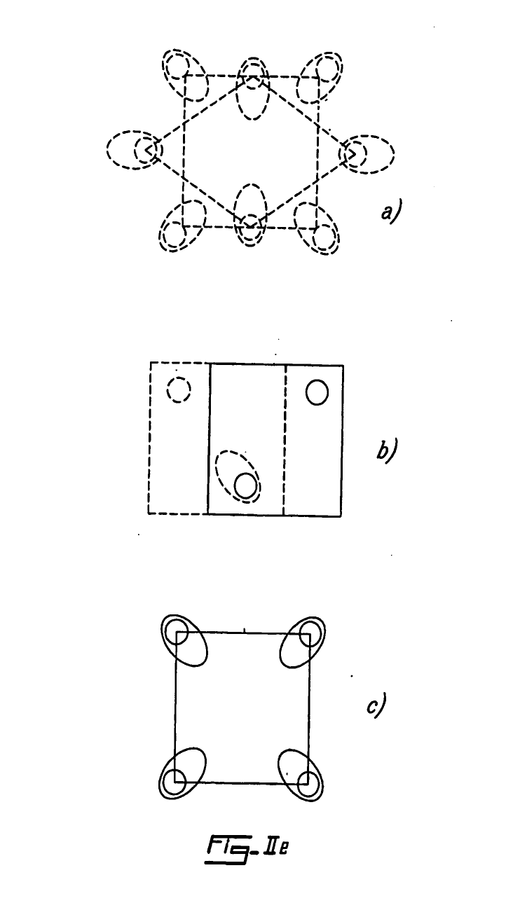

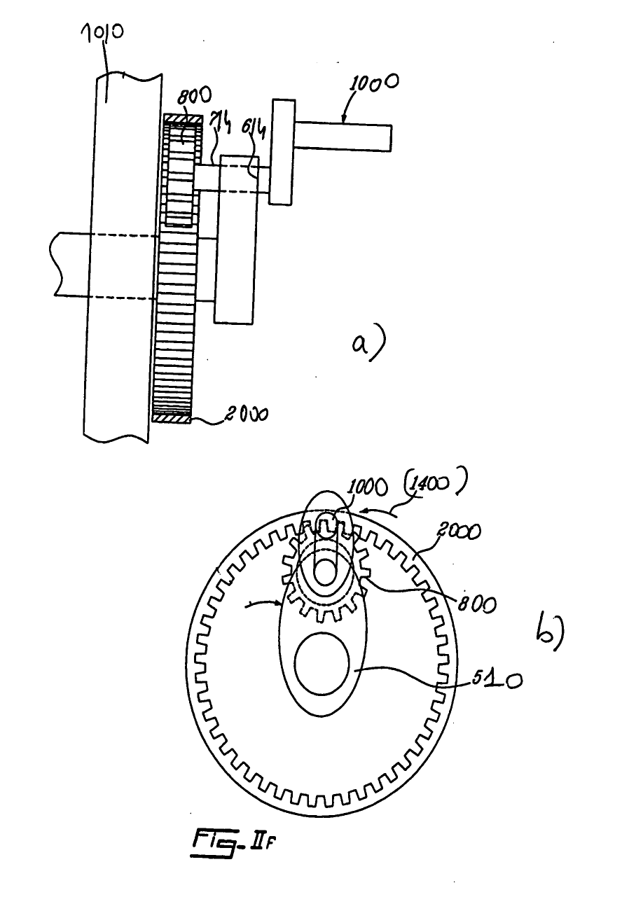

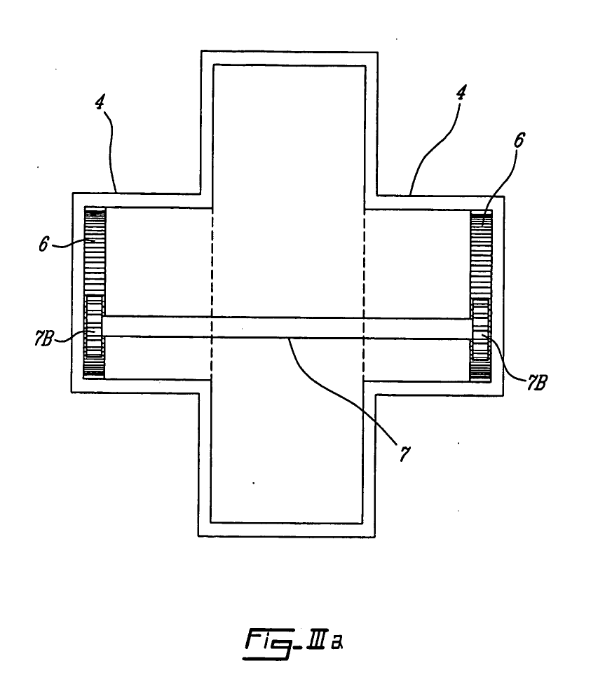

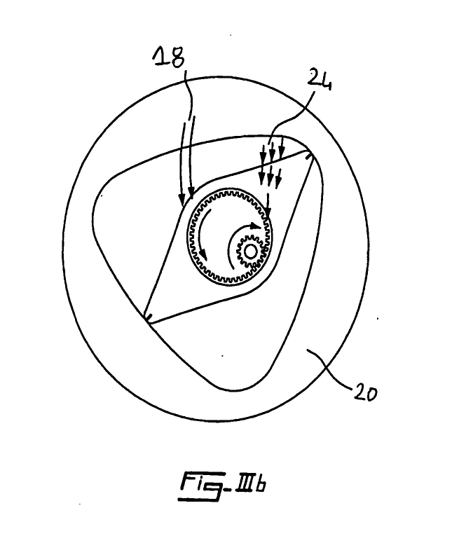

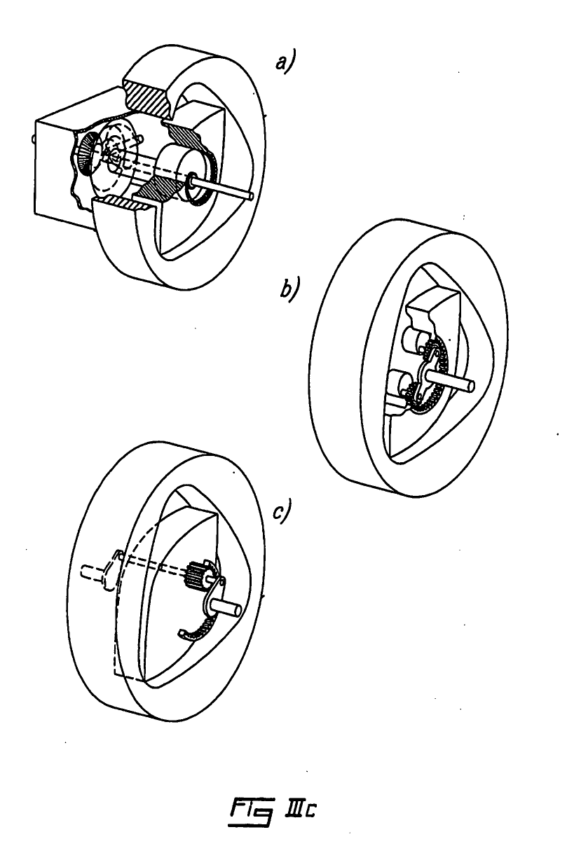

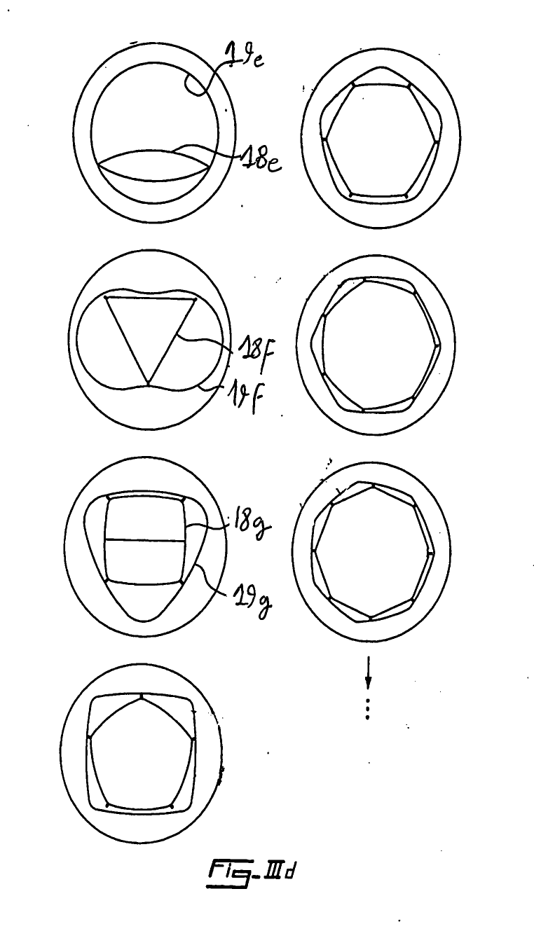

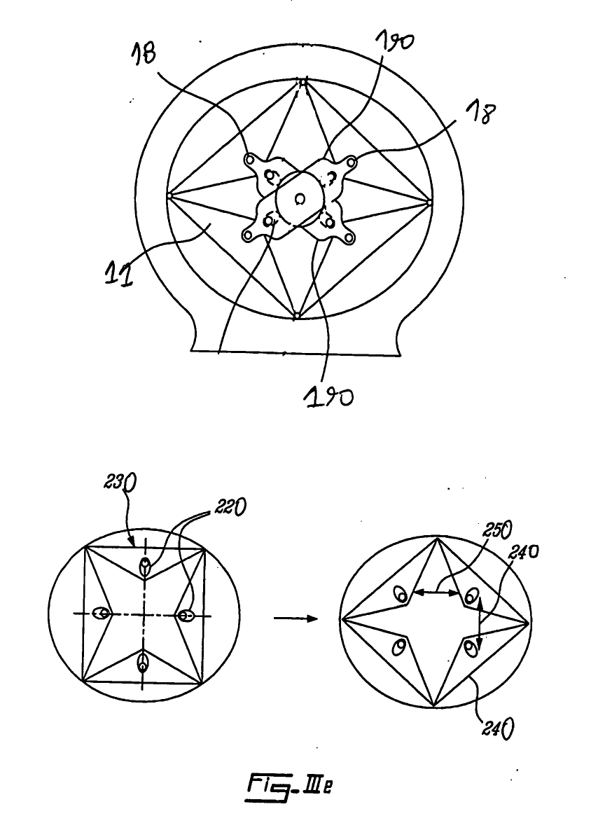

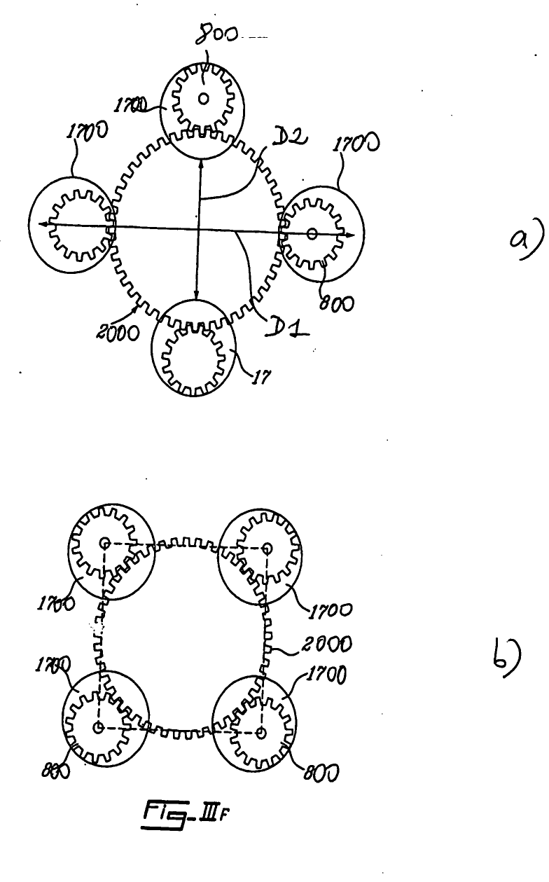

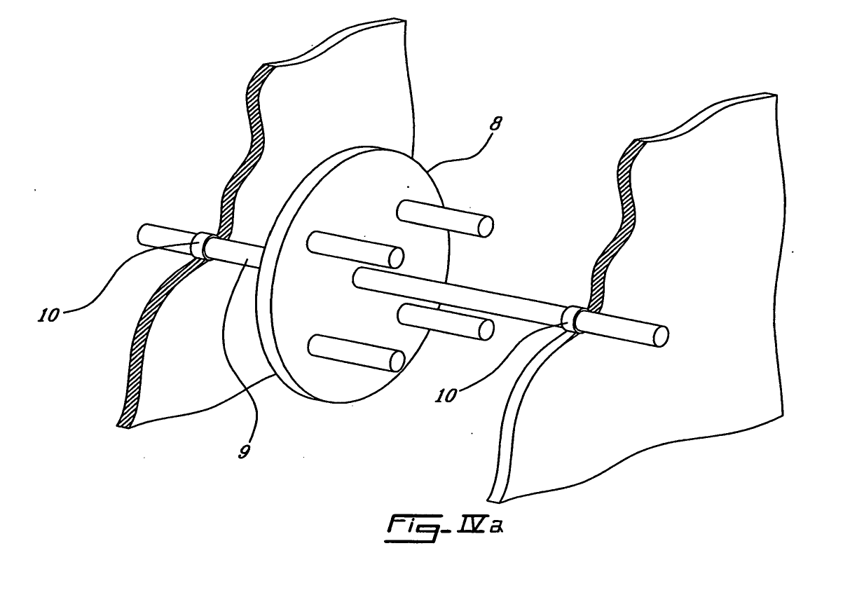

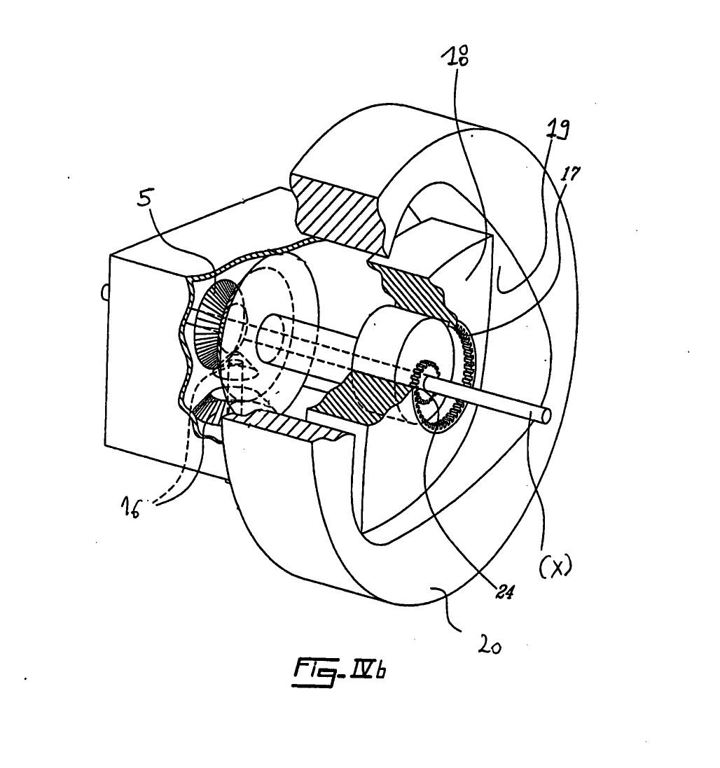

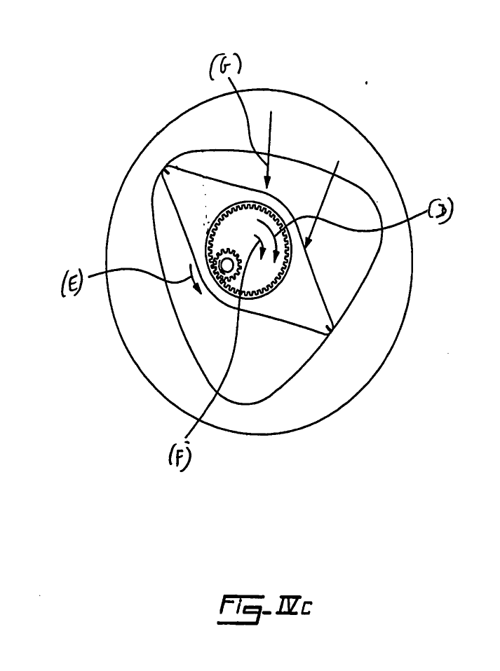

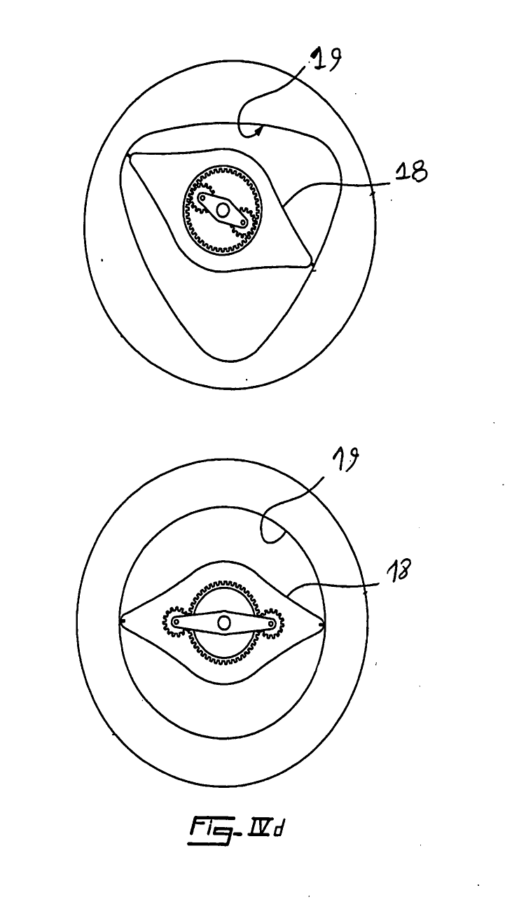

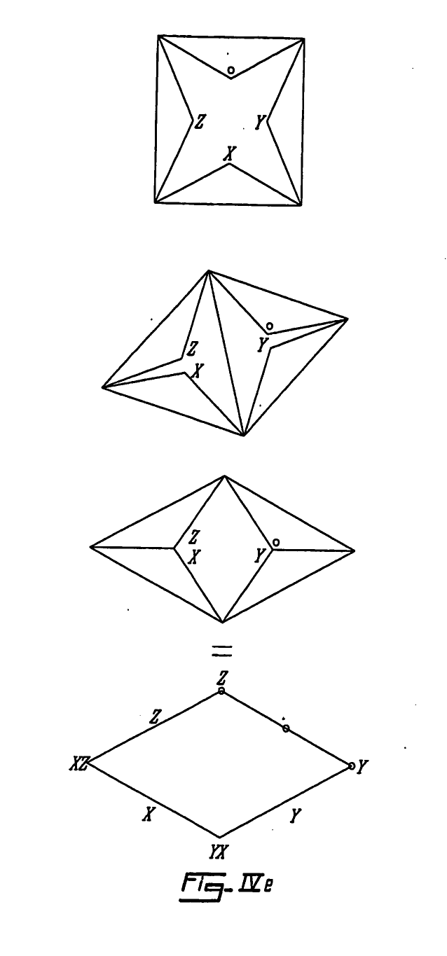

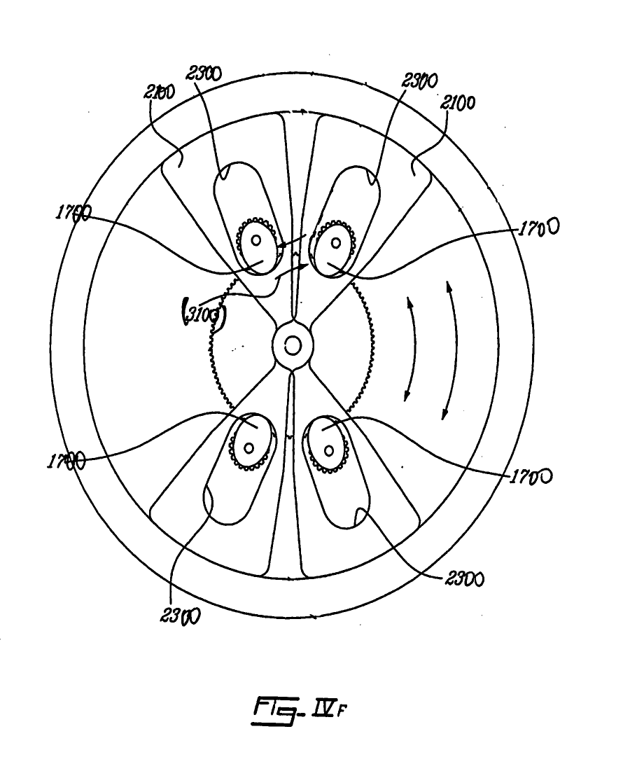

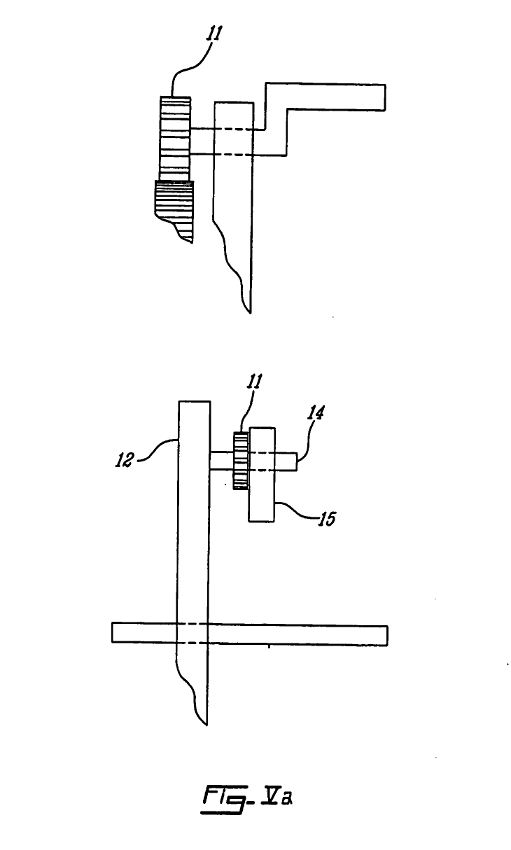

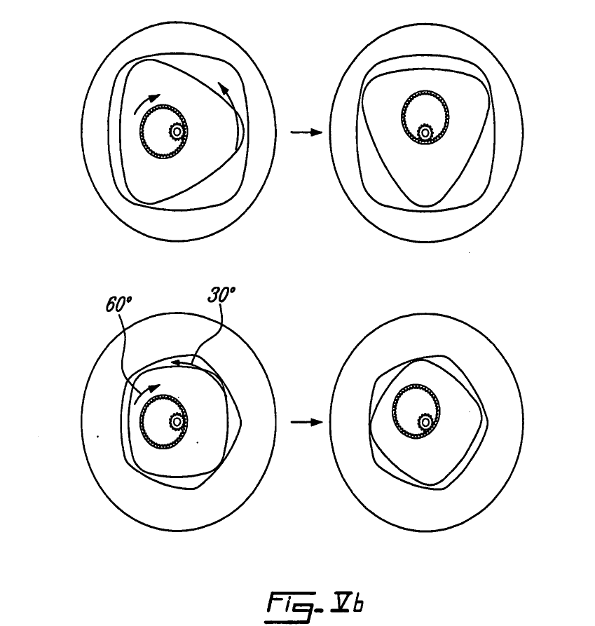

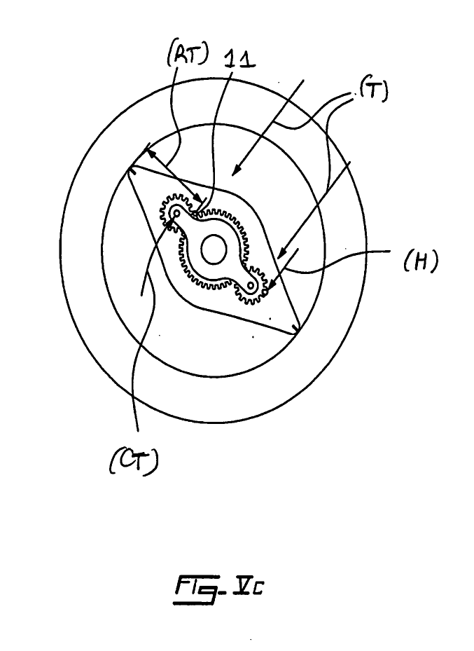

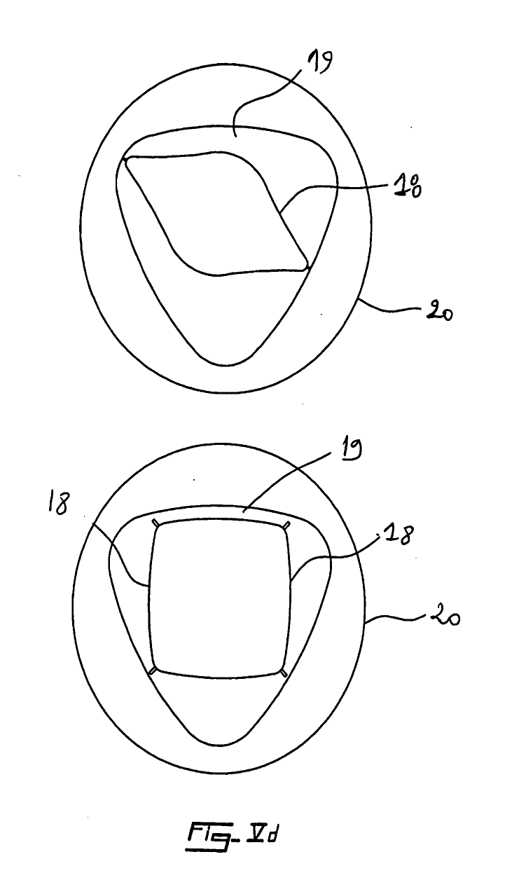

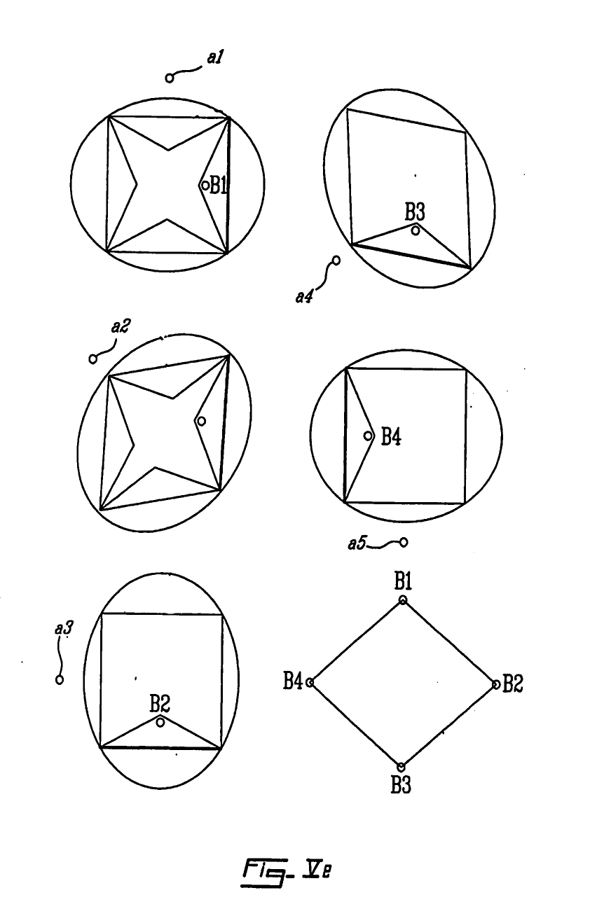

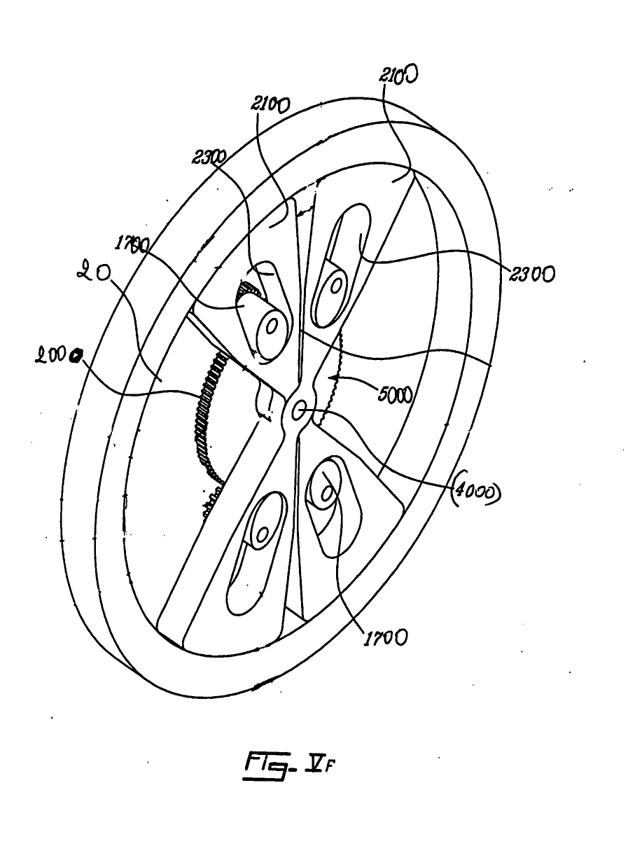

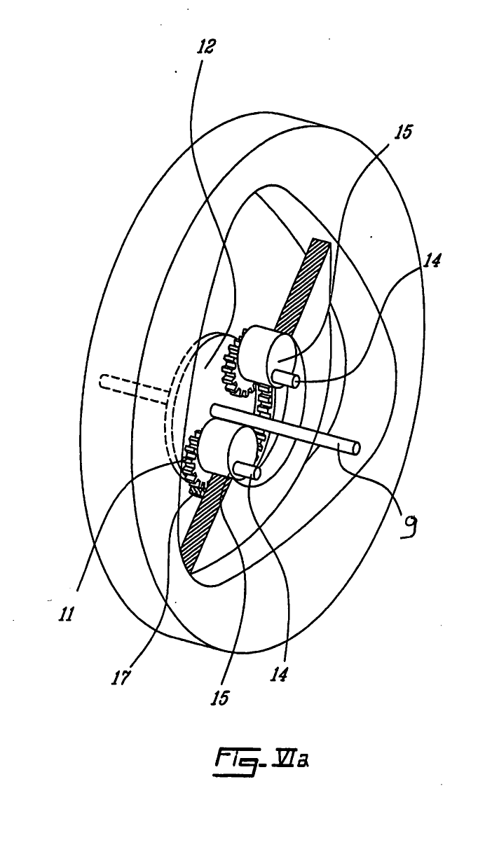

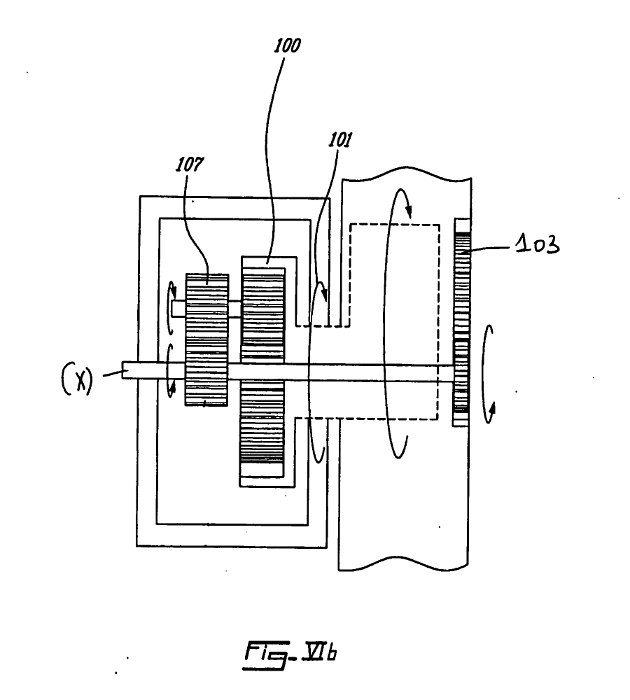

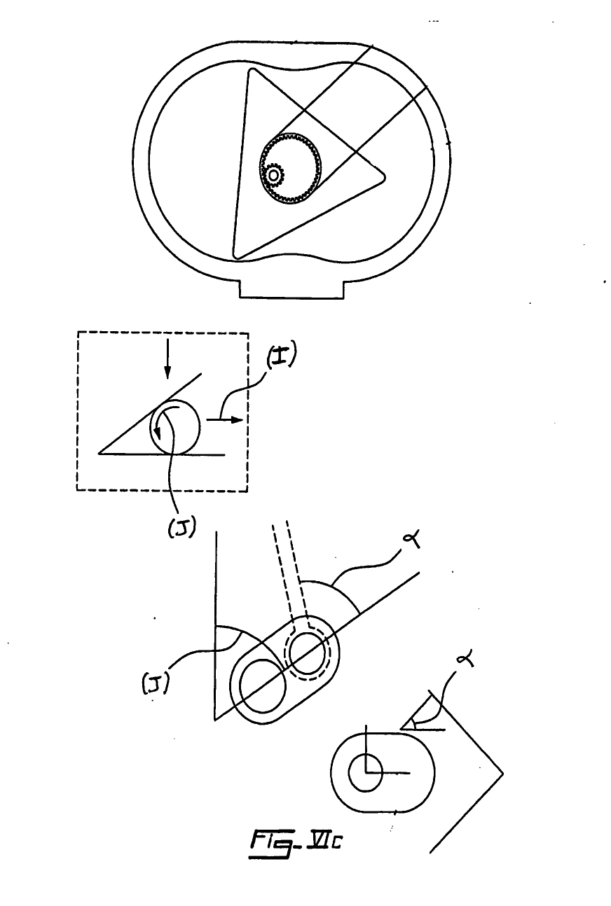

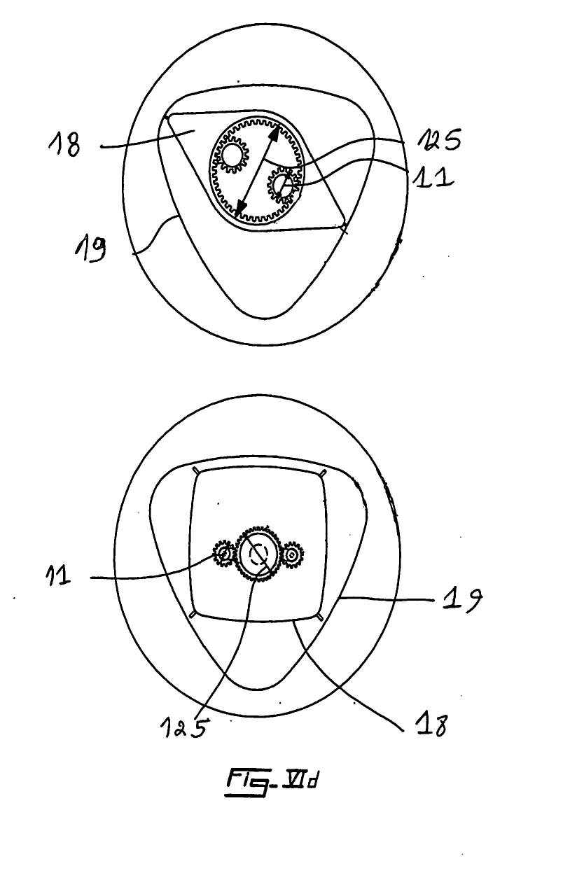

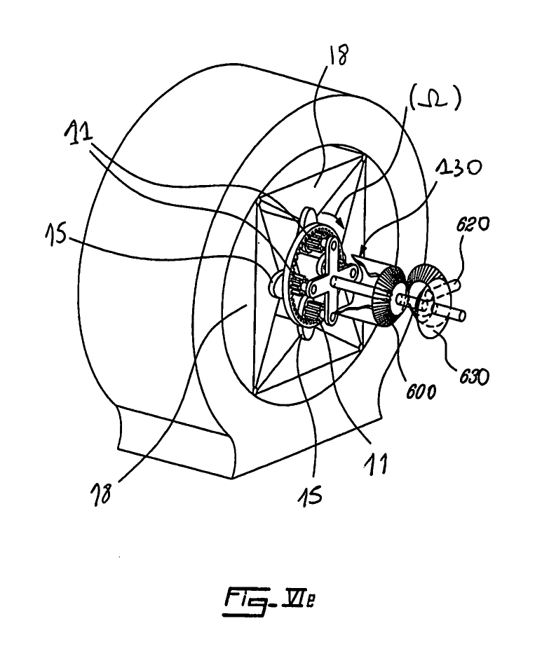

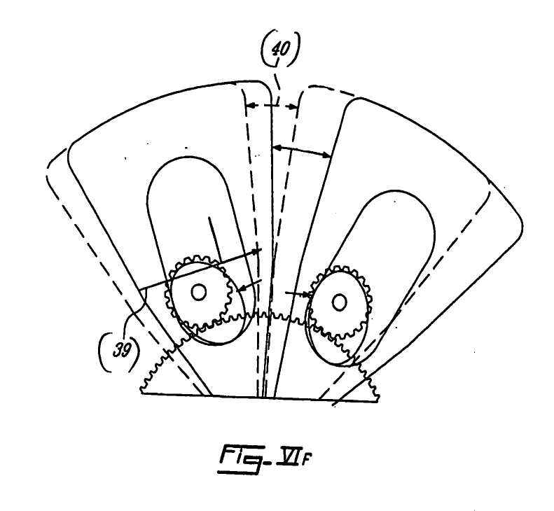

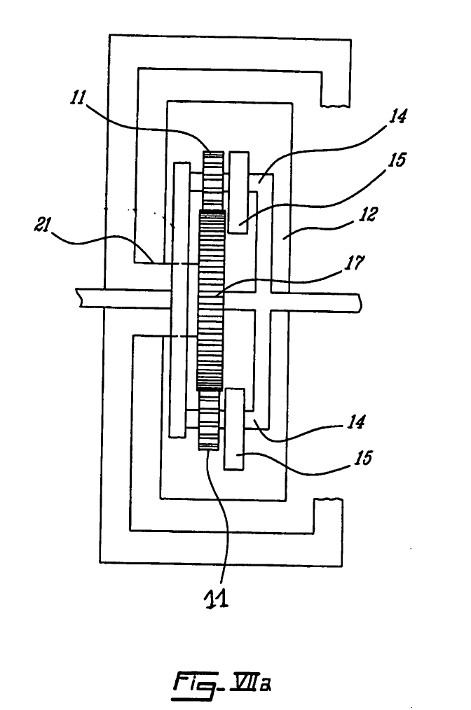

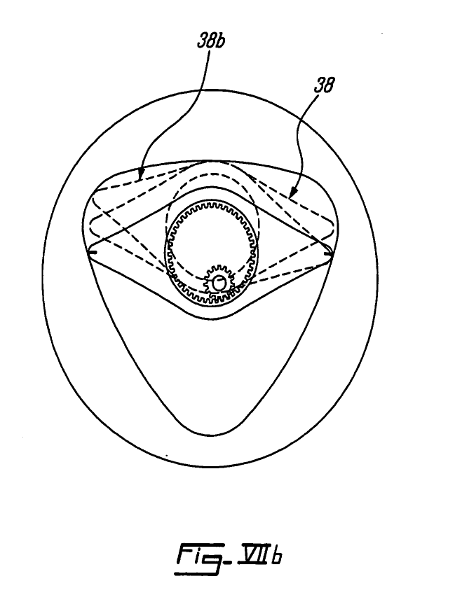

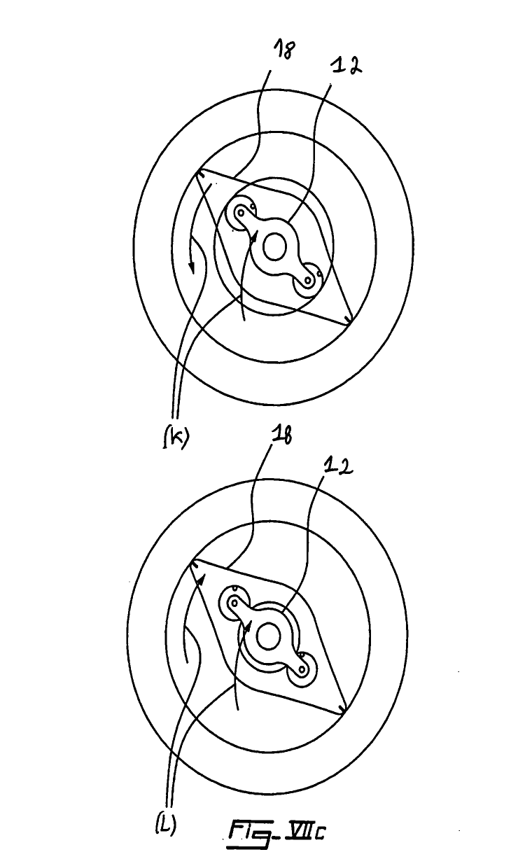

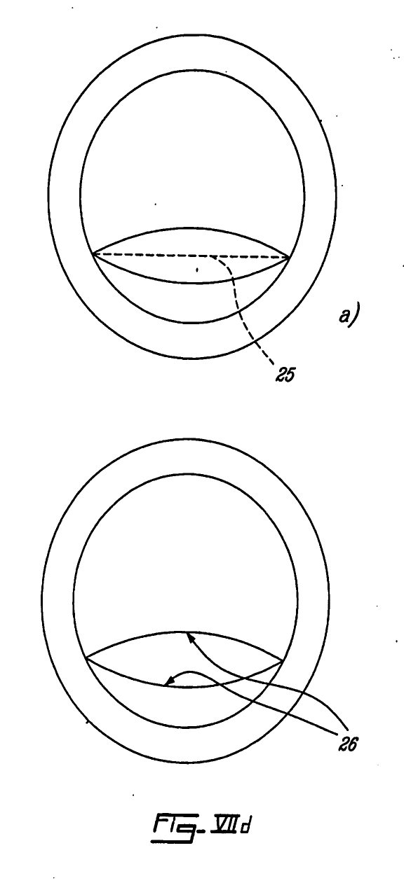

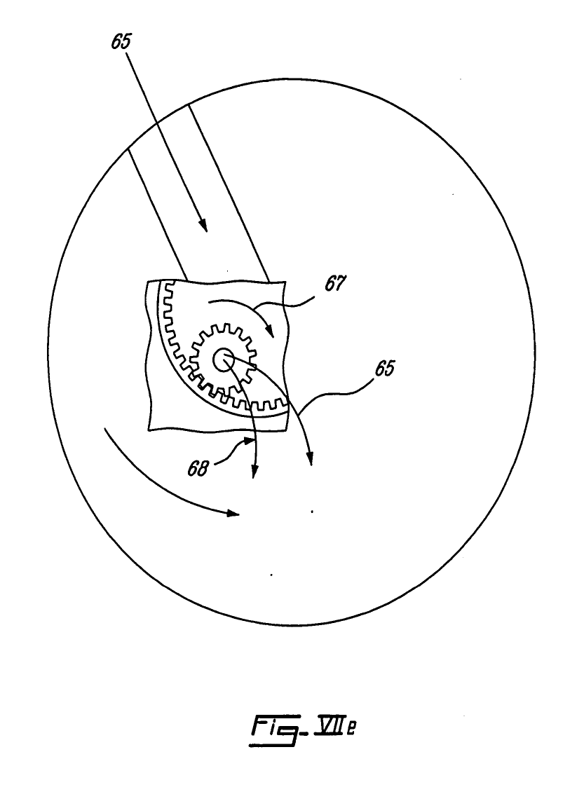

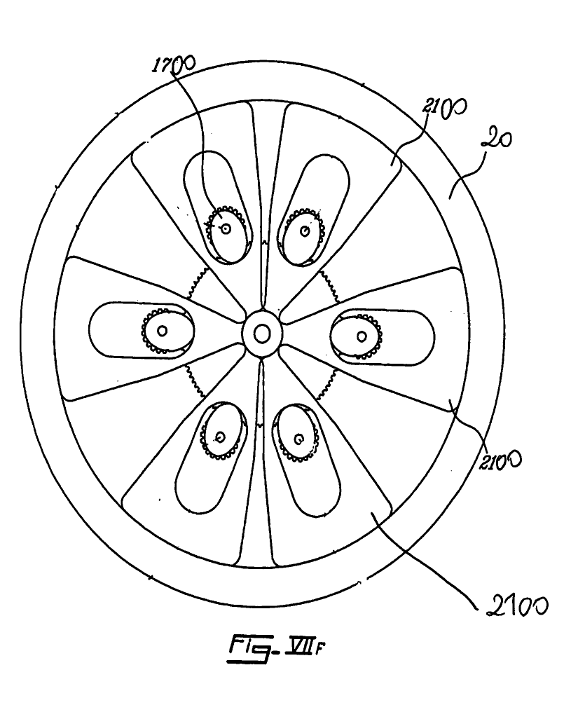

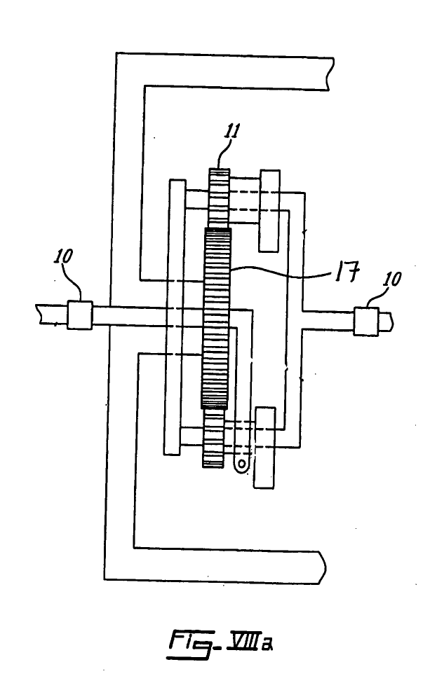

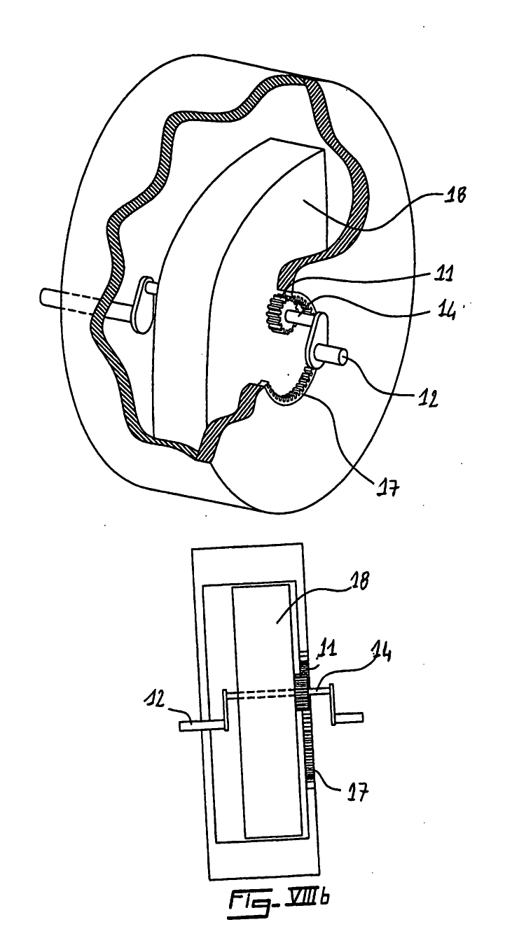

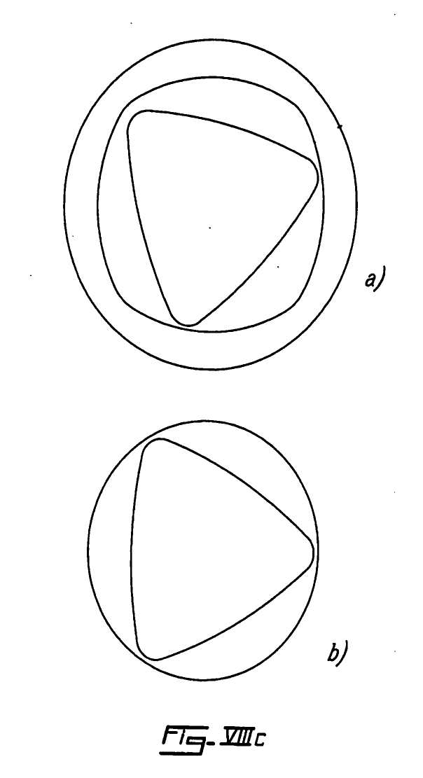

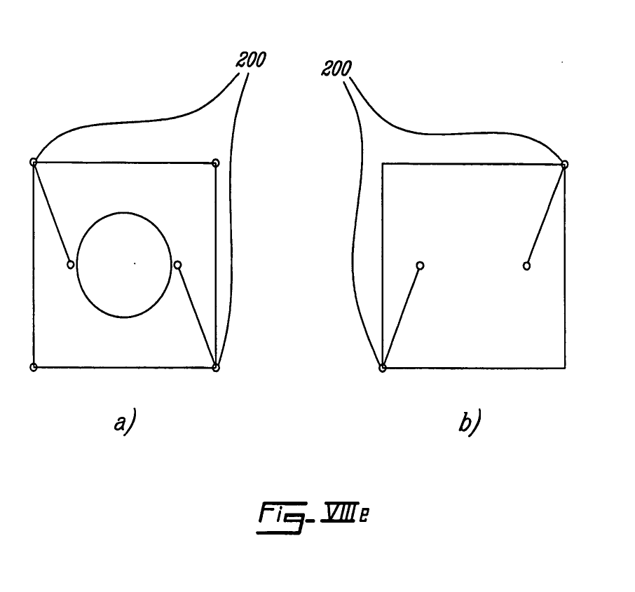

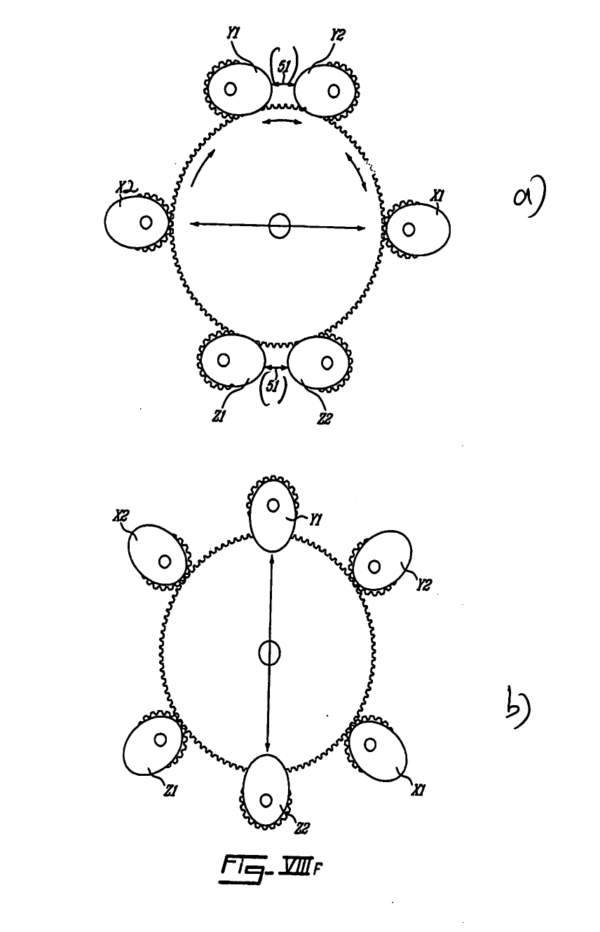

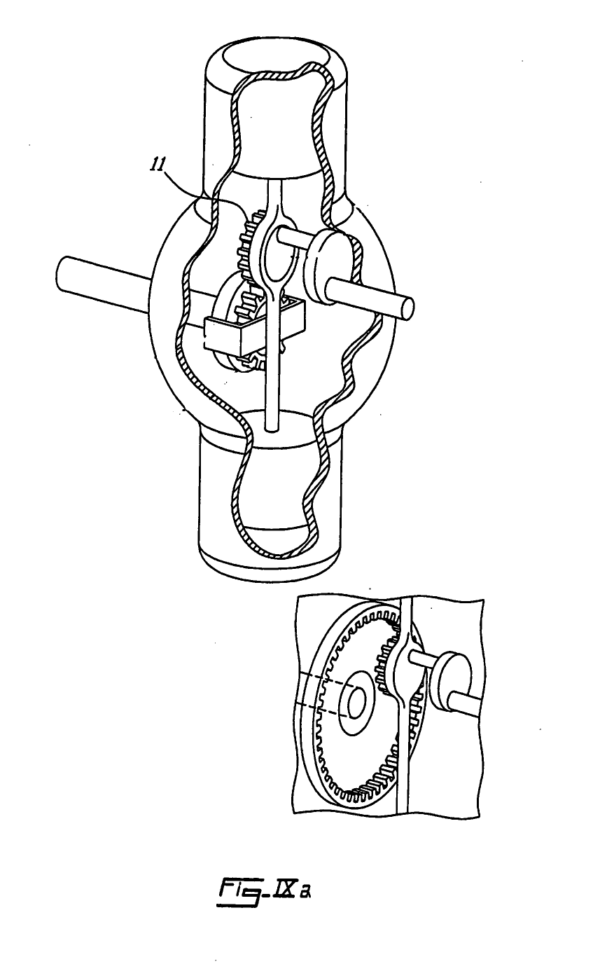

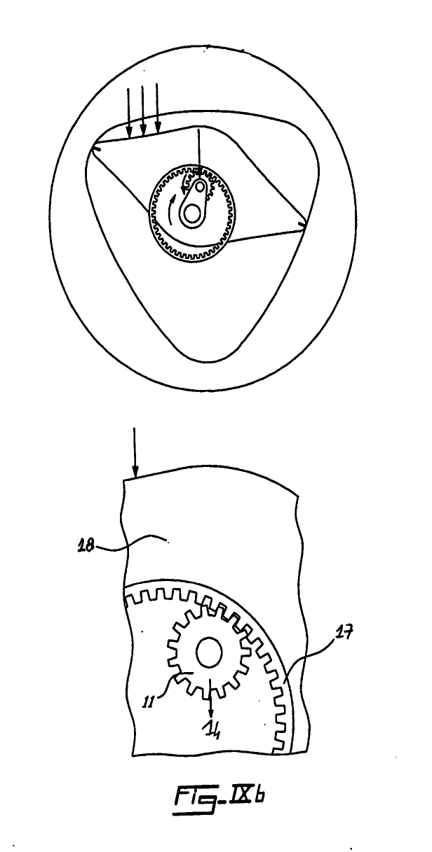

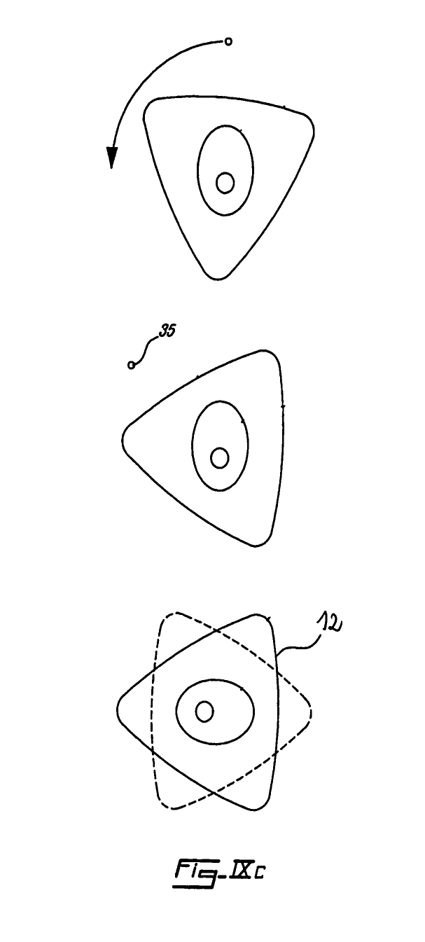

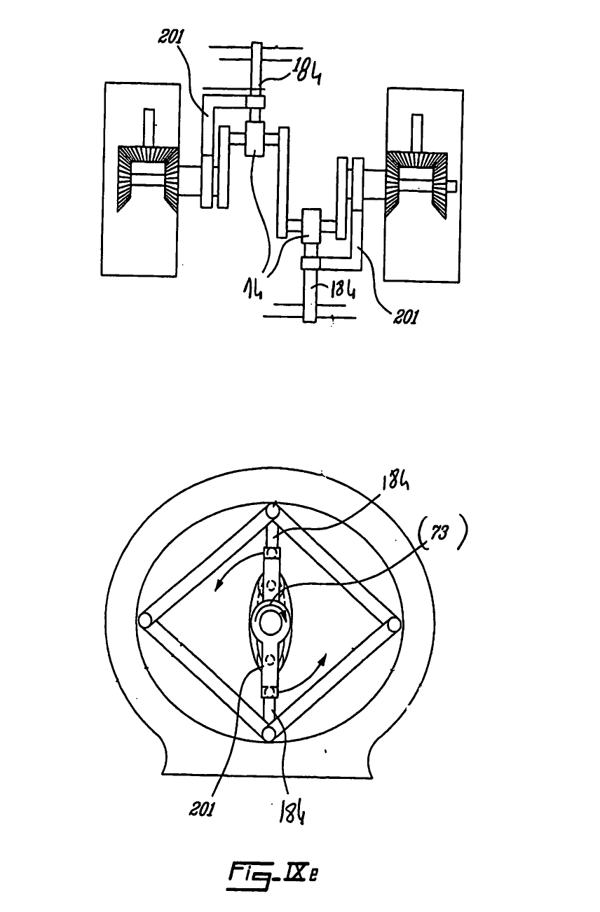

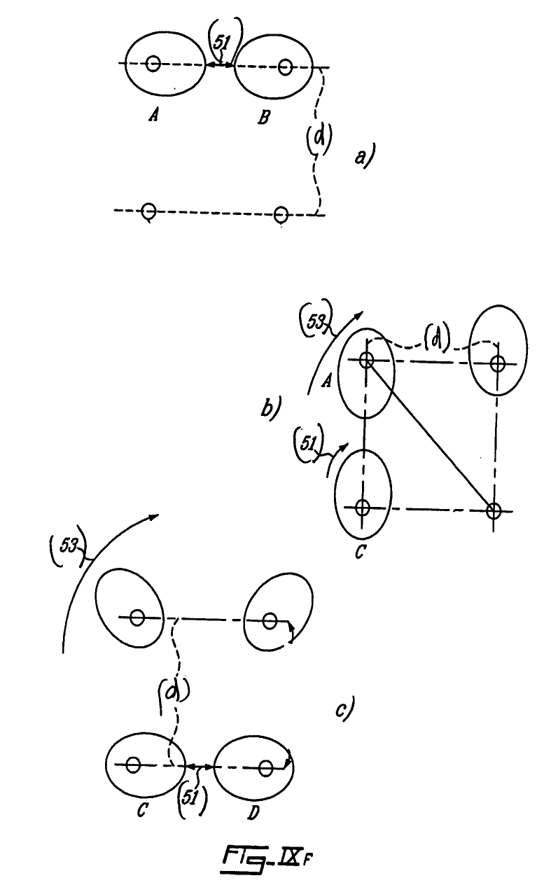

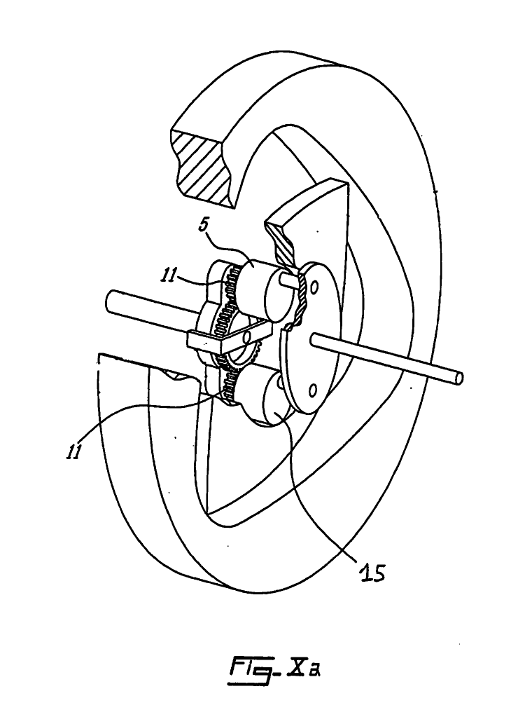

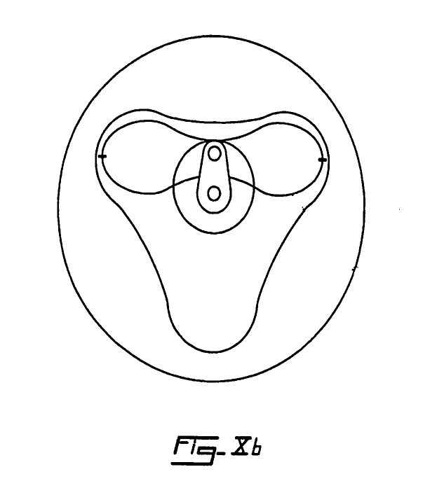

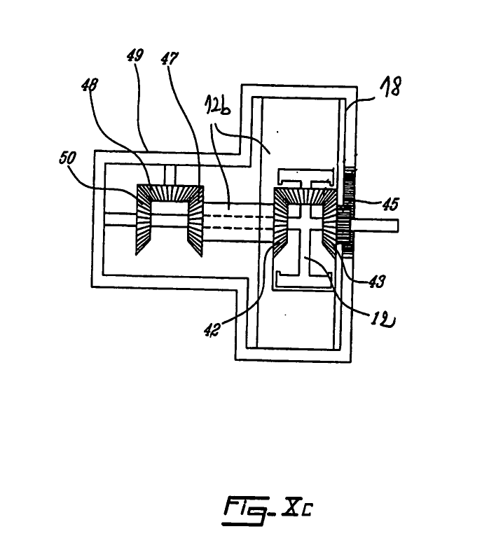

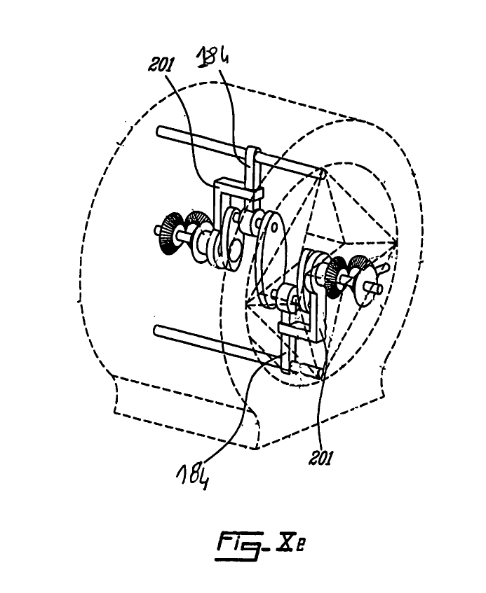

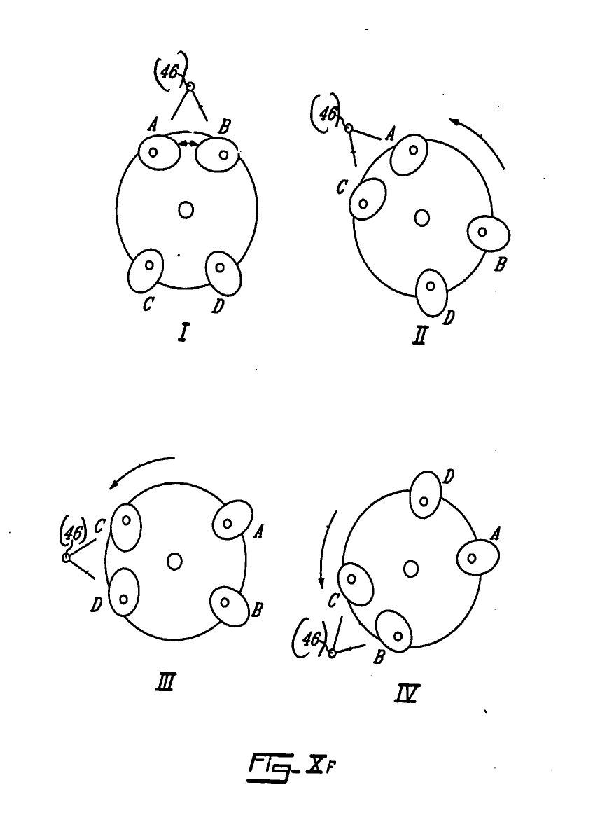

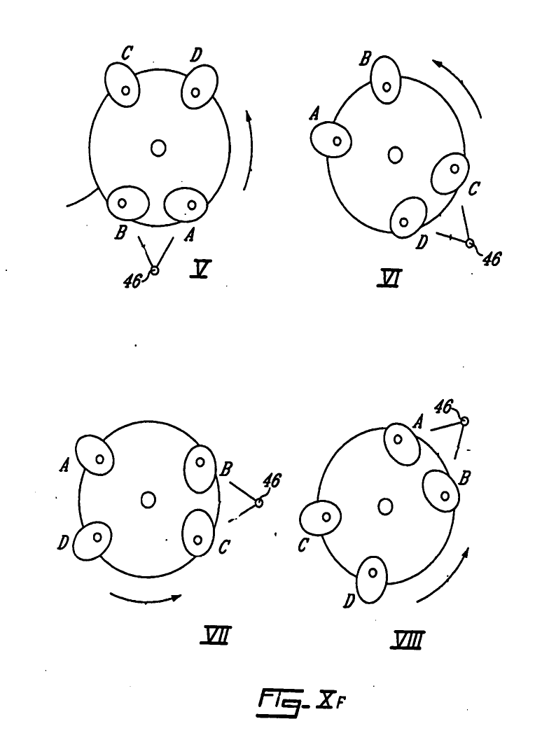

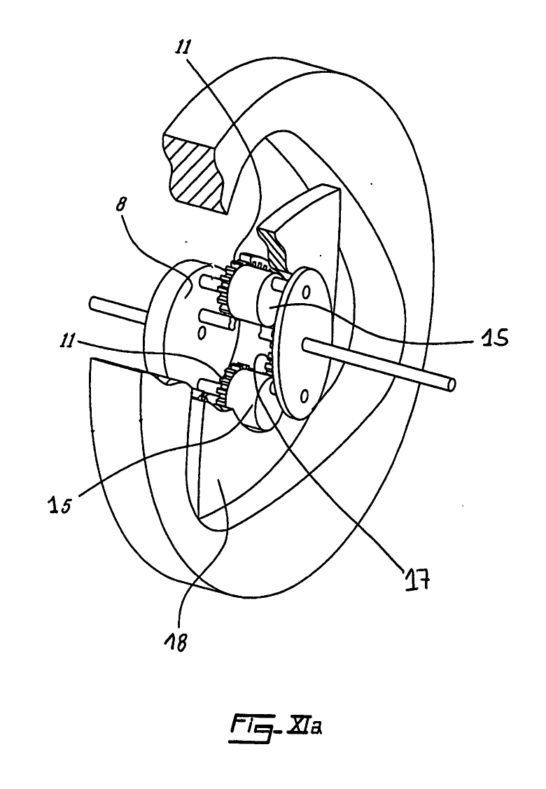

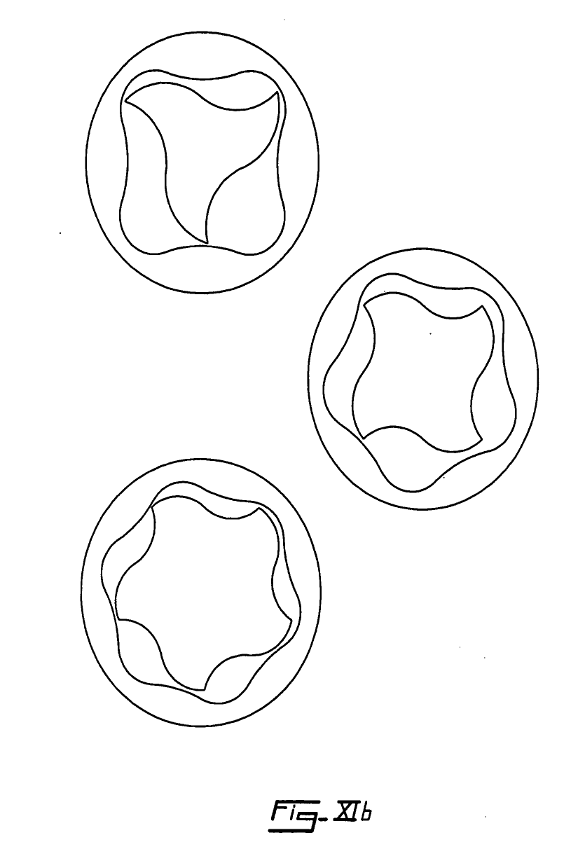

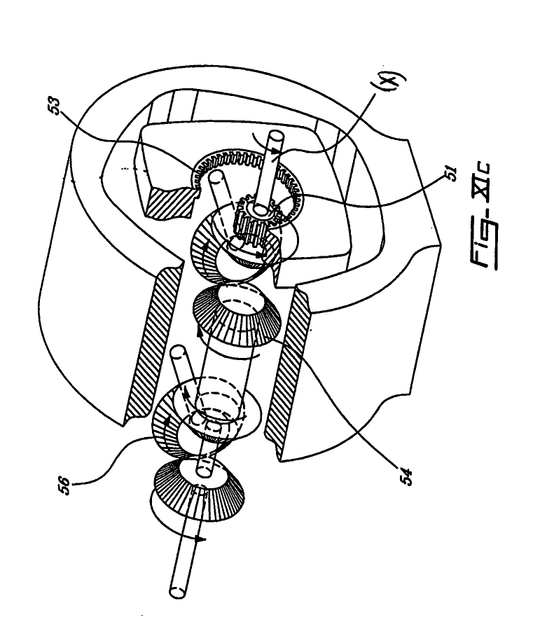

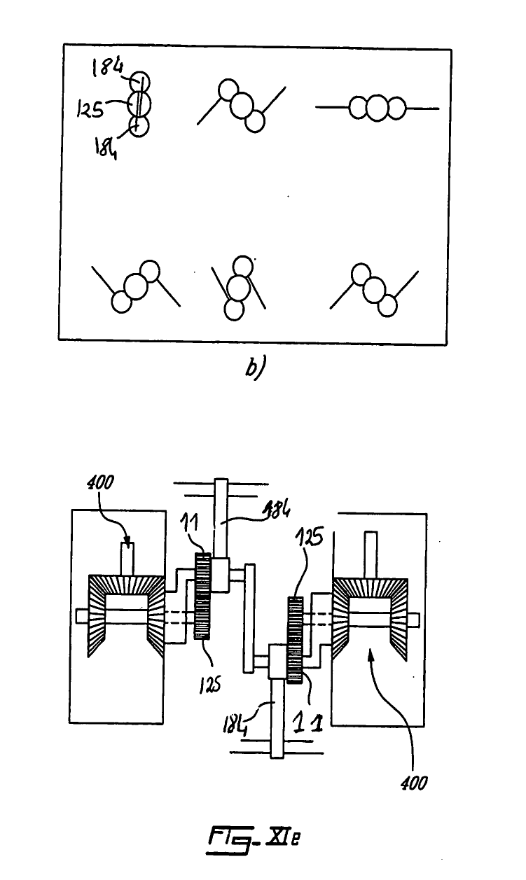

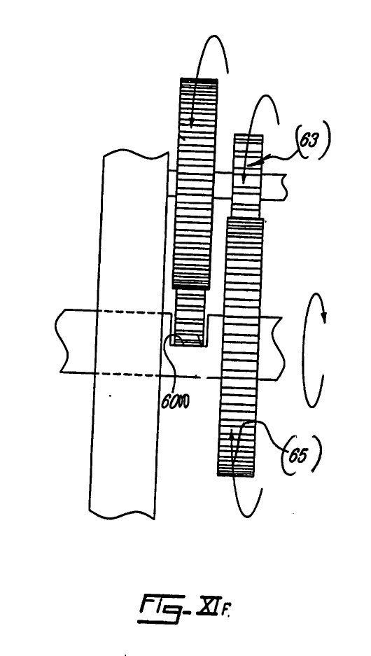

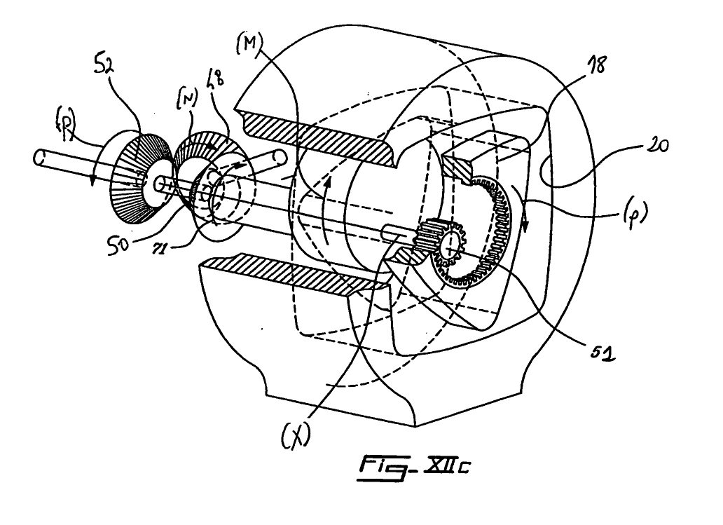

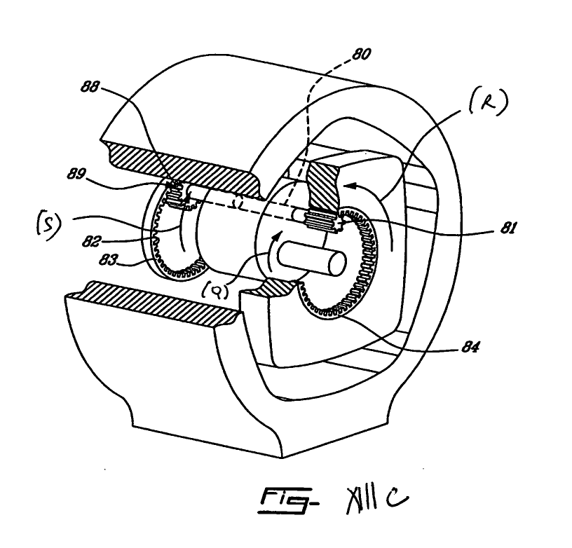

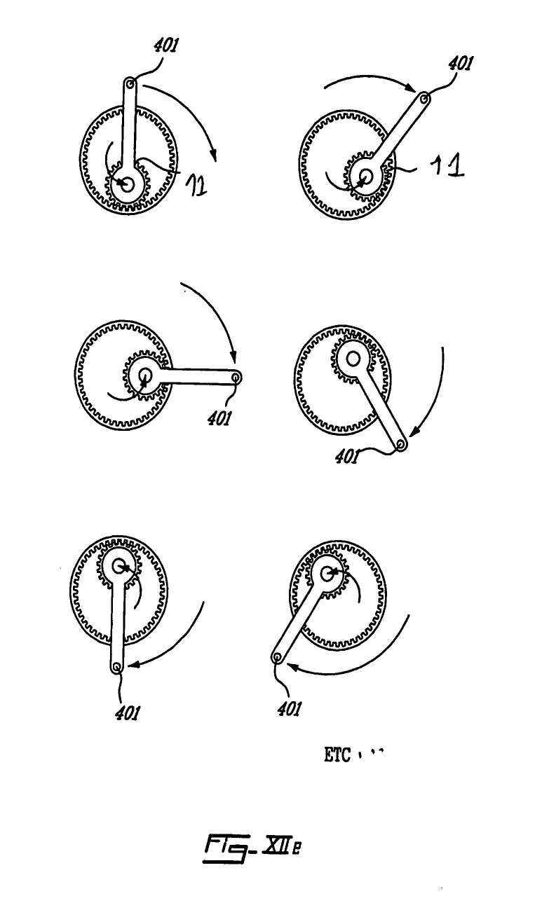

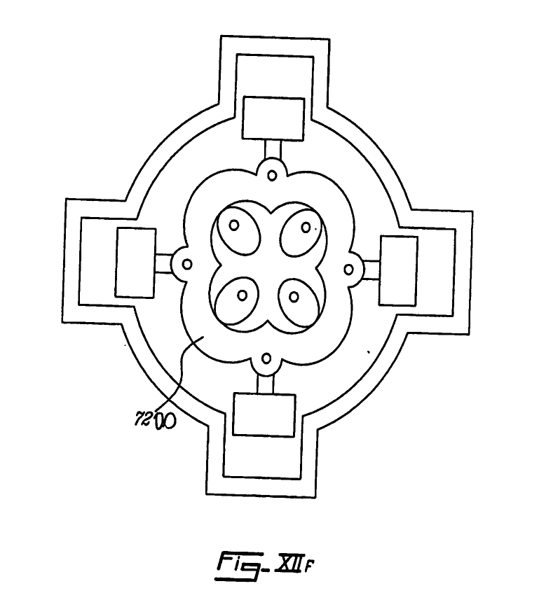

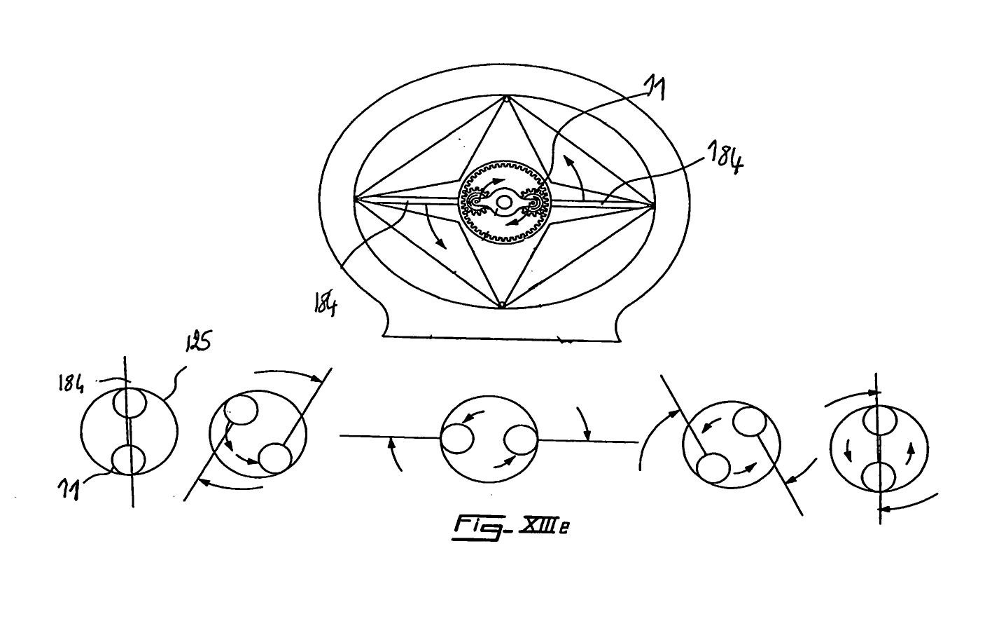

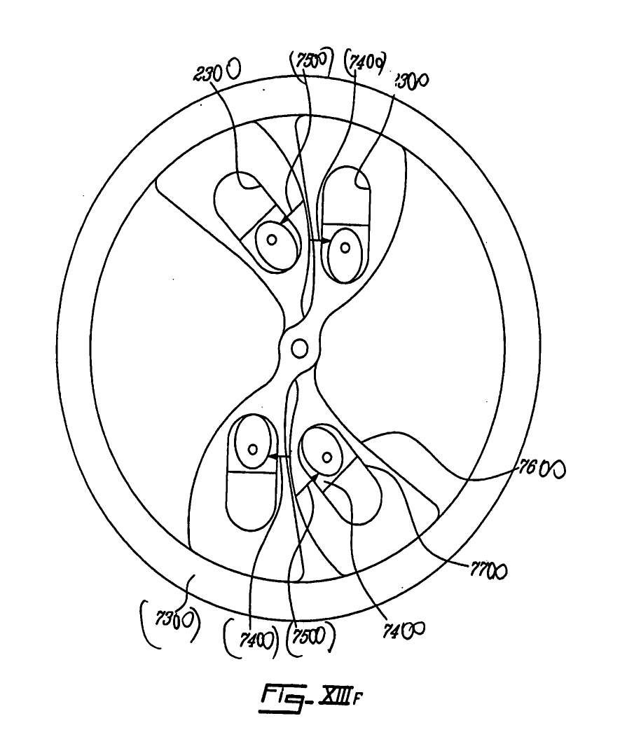

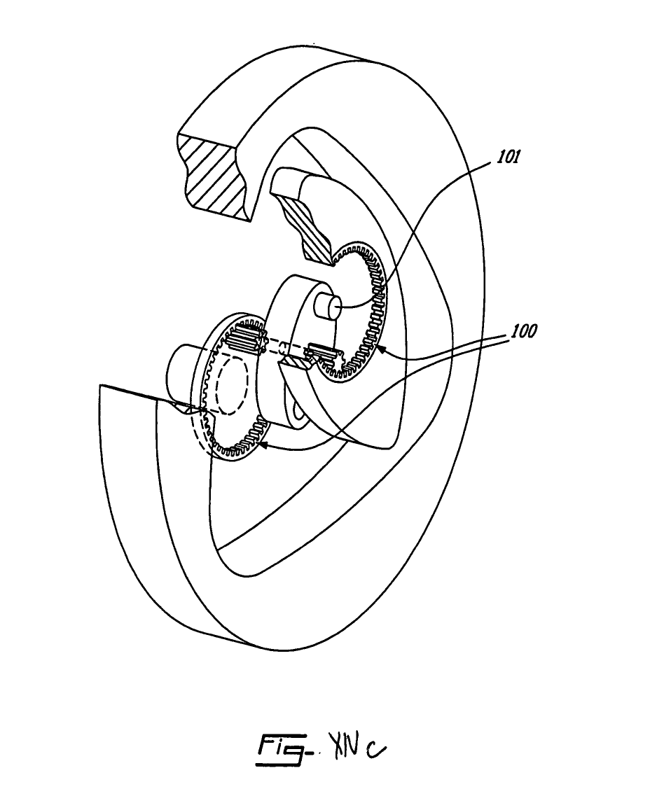

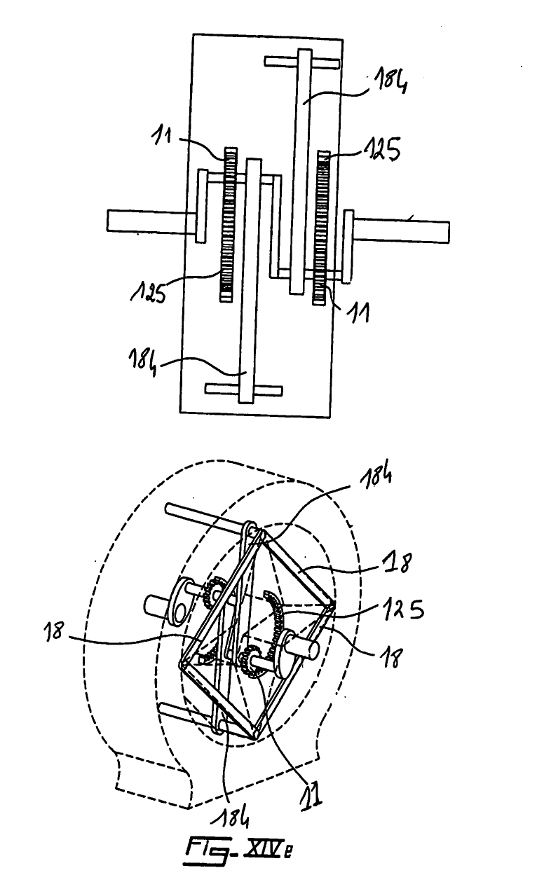

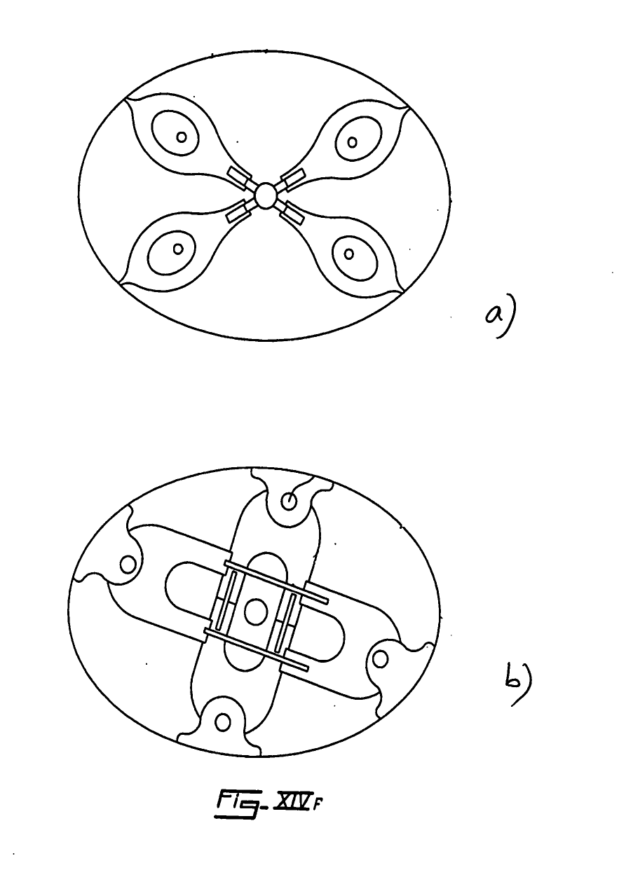

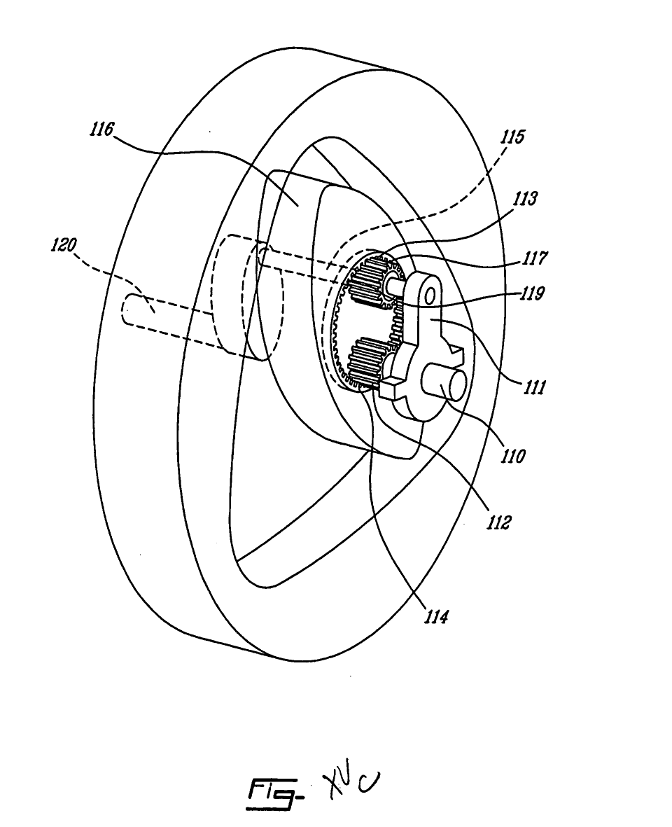

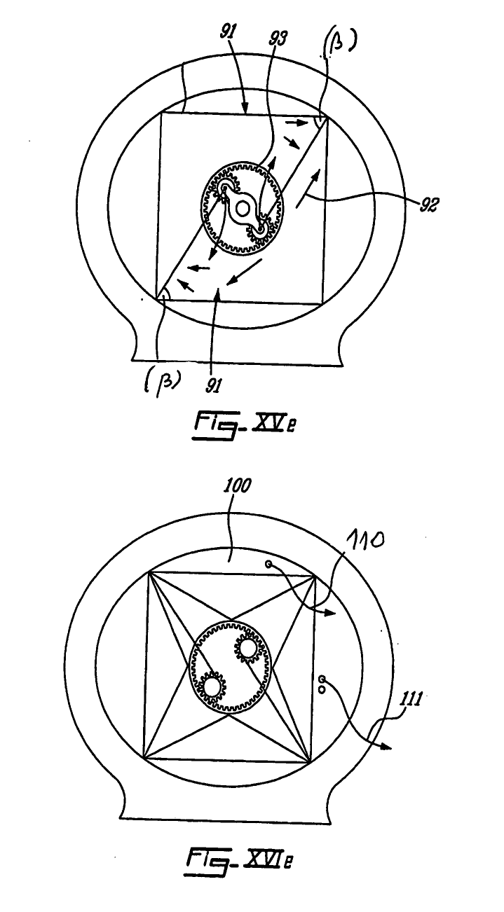

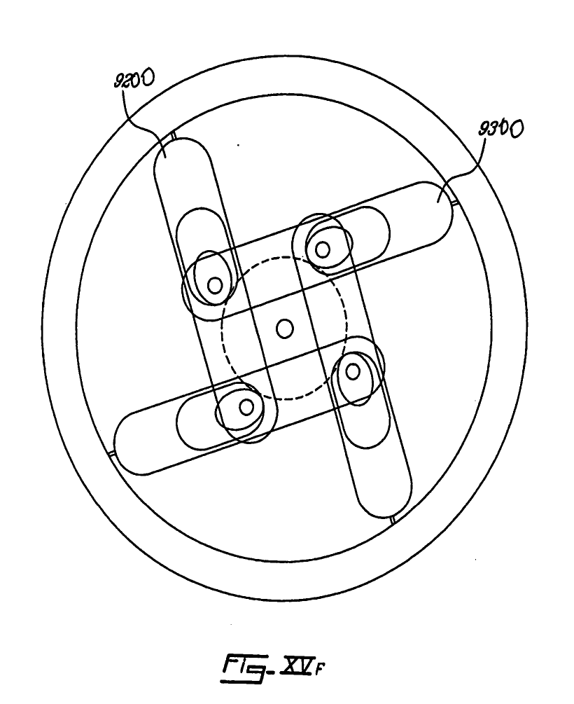

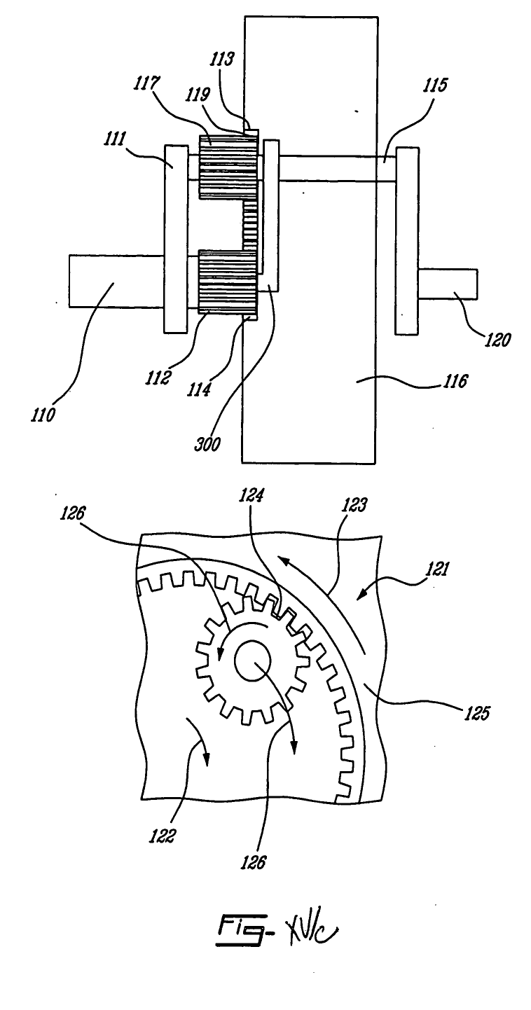

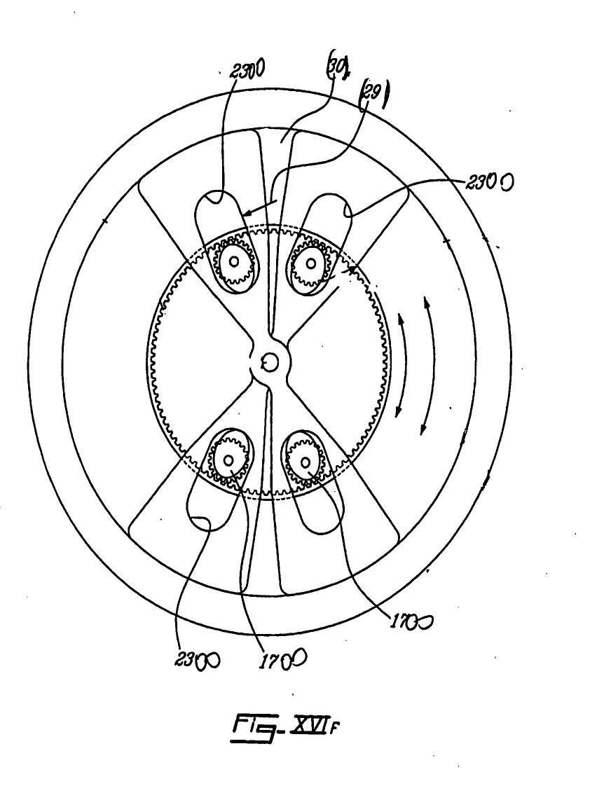

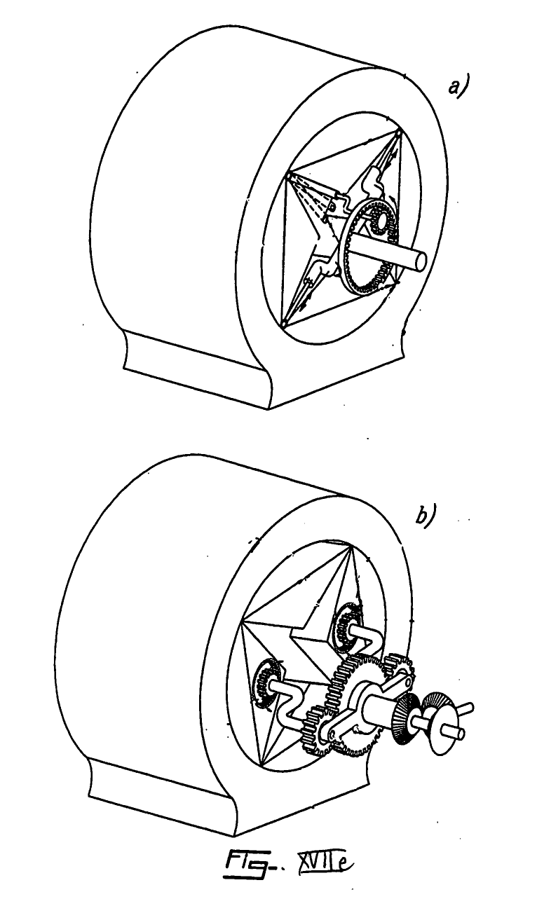

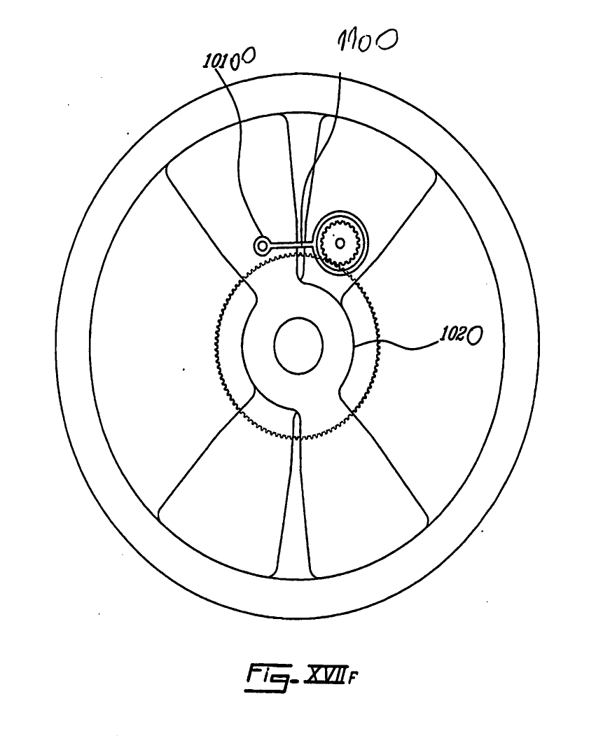

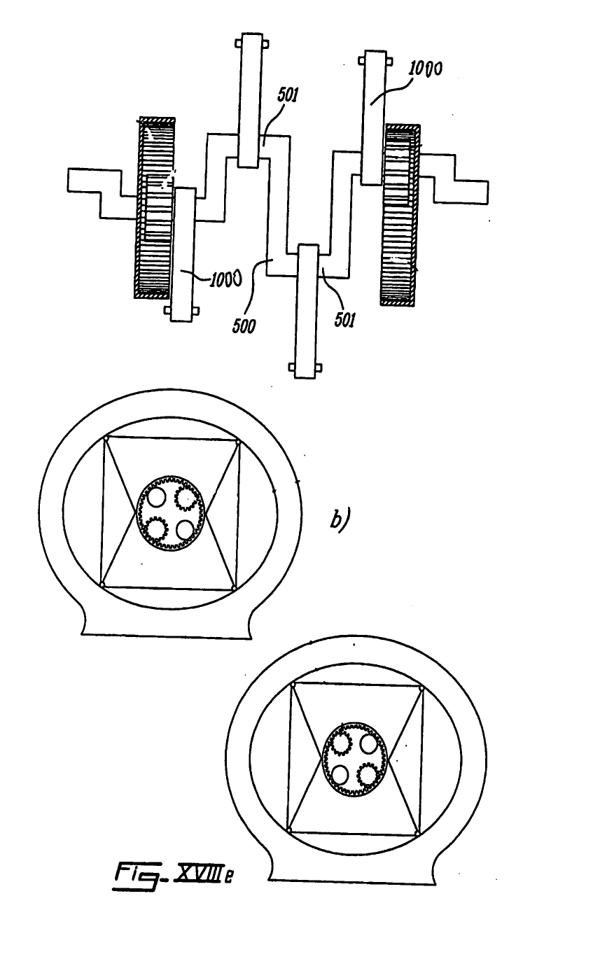

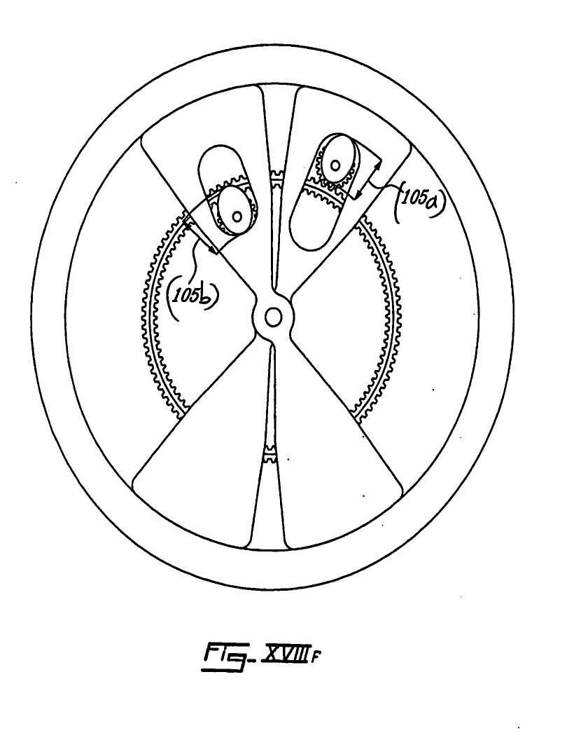

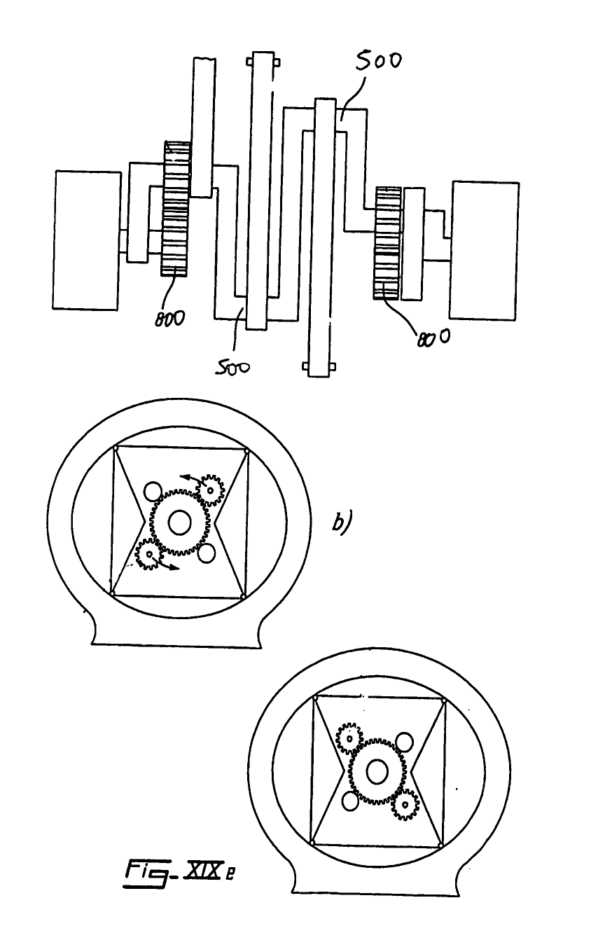

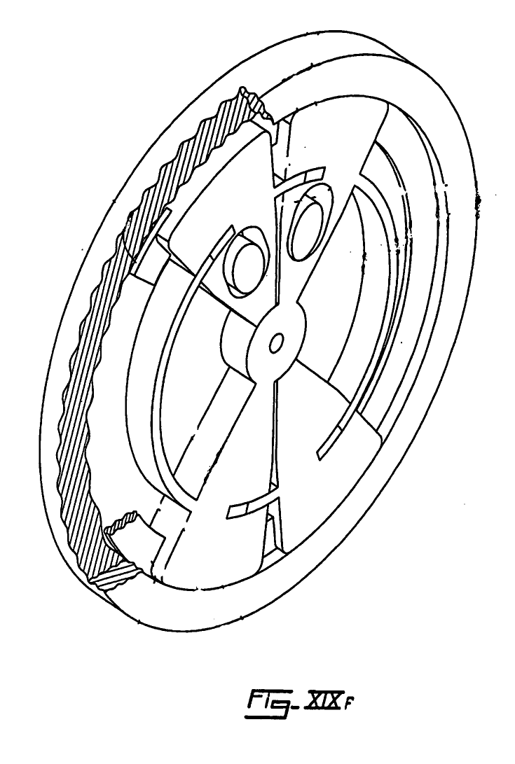

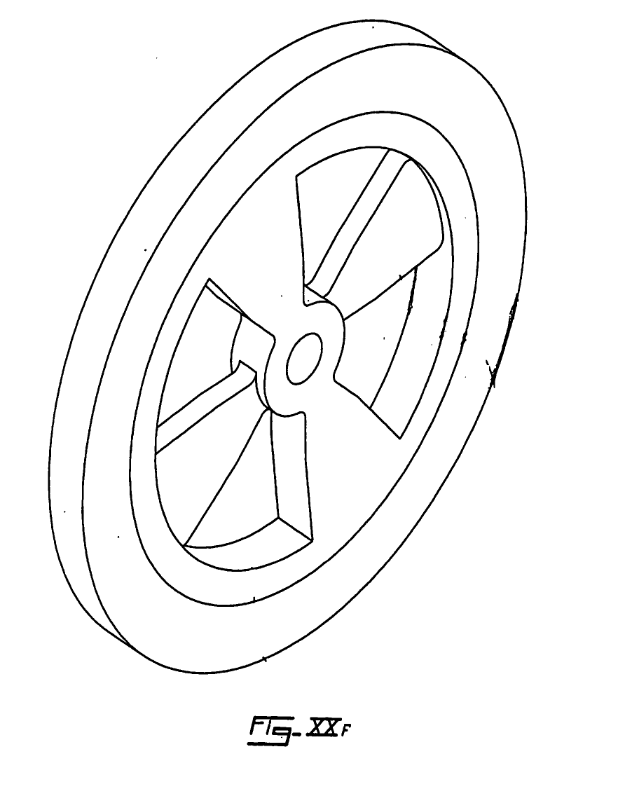

### CROSS REFERENCE TO RELATED APPLICATIONS

This application is a continuation application of U.S. patent application Ser. No. 10/471,427, filed Feb. 12, 2004, and claims priority on PCT application no CA02/00340 filed on Mar. 11, 2002 and published in English under PCT Article 21(2). All documents above are herein incorporated by reference.

### BACKGROUND OF THE INVENTION

There is a need for support systems for poly-induction engines, in particular for improvements to poly-induction methods for supporting elements of an engine by providing a mechanical structure able to advantageously equilibrate the span of gear means and bearing means, thereby allowing a structure with limited unbalanced friction between the poly-induction pieces.

### SUMMARY OF THE INVENTION

There is provided a poly-inductive rotative machine comprising a compressive member, wherein induction of the compressive member is achieved by a mechanism realizing a positive induction on both a front and a back surface thereof, the mechanism being selected in the group consisting of a semi-transmission, a double semi-transmission, a side transmission, a pivot gear assembly, a poly-induction cam assembly, a poly-induction connecting rod assembly and a poly-induction sliding coupling assembly.

### BRIEF DESCRIPTION OF THE FIGURES

Figure I a illustrates a number of examples of poly-induction engines wherein unbalance is due to the fact that the gear means are located only on one side of the blade;

Figure II a is a transverse view of a semi-transmission;

Figure III a illustrates a first embodiment using two interconnected complementary systems;

Figure IV a illustrates a first embodiment of a bridge-type semi-transmission;

Figure V a illustrates improvements of the induction gears;

Figure VI a illustrates a second embodiment of the bridge-type semi-transmission;

Figure VII a illustrates an embodiment wherein the semi-transmission nested in the blade itself;

Figure VIII a illustrates a semi-transmission that leaves the axis disengaged;

Figure IX a illustrates a first use of this type of bridge semi-transmission in a rectilinear reciprocating engine;

Figure X a illustrates features in a retro-rotative semi-transmission, which allow building, in a very balanced way, a triangular engine;

In Figure XI a, the blade is rigidly connected to the induction gear, and at the same time mounted about the supporting axis of the bridge; the induction gear is coupled to an internal type supporting gear located in the side of the engine;

Figure I b illustrates a first embodiment of a poly-inductive triangular engine;

Figure II b shows that by using an inversion semi-transmission, retro-rotative engines may be built with two inductions, here induced by their center, namely an eccentric member and a central internal gear;

Figure III b shows the forces occurring during the rotative way down of the blade;

Figure IV b is a three-dimensional view of the embodiment of Figure II b;

Figure V b further details the embodiment of Figures II b and IV b;

Figure VI b illustrates a further embodiment wherein the semi-transmission modifies both the direction of rotation of the axis and a speed thereof.

Figure VII b shows a drawback of the embodiment of Figure VI b, which results in a deficient compression.

Figure VIII b illustrates a further embodiment of the invention, wherein the semi-transmission elements are cancelled and a differently laid up poly-induction is provided. The two dynamical points of the engine are now in the center operating the crankshaft, and the internal type induction gear, which is located on the center of the connecting rod about the connecting rod journal, is engaged with the internal supporting gear located in the side if the part. The figure also shows the desired objective of such an assembly, namely the improvement of compression. As before, this embodiment maintains all the retro-active characteristics.

Figure IX b is a schematic view of the forces occurring during the rotating way down of the blade, in the embodiment of Figure VIII b.

Figure X b shows that it is even possible to supercharge the system by using an improved design of the blades.

Figure XI b shows a number of such engines may be built;

Figure I c illustrates examples of poly-inductive engines;

Figure II c shows a generalization of poly-inductive engines;

Figure III c illustrates embodiments of retro-rotative engines of the prior art;

Figure IV c illustrates forces acting in the engines of Figure III c;

Figure V c shows advantages of mounting a post-rotative engine in a poly-rotative way;

Figure VI c illustrates a known set up of mono-inductive rotative engines;

Figure VII c illustrates differences existing between retro-and post-rotative engines;

Figure VIII c shows that the retro-rotative effect may not be directly achieved in a post-rotative engine.

Figure IX c illustrates a different way of analyzing the movement of the blade with regard to that of the crankshaft;

Figure X c illustrates a first embodiment of a retro-rotataly mounted post-rotative engine.

Figure XI c shows a complete control of all thrust forces on the blade and of the deconstruction of the system.

Figure XII c is a perspective view of the engine of Figure X.

Figure XIII c is an off center embodiment of the present invention;

Figure XIV c is another view of the off-center embodiment of Figure XIII;

Figure XV c illustrates a use of an internal gear in the semi-transmission;

Figure XVI c shows the energy distribution during expansion of the system of Figure XV c;

Figure I d illustrates two embodiments of poly-inductive vane-type engines, wherein the first one is retroactive with a triangular cylinder, and the other one is rotative with a square blade;

Figure II d shows a series of drawings illustrating the side rule applied to retro-rotative engines;

Figure III d shows a series of drawings illustrating the side rule applied to post-rotative engines;

Figure IV d is a comparison of two types of engines for a blade with a given number of sides;

Figure V d is a comparison of these two types of machines or engines for a cylinder having a number of sides equal to three;

Figure VI d gives an overview of the gear ratios to be observed;

Figure VII d shows borderline cases of convergence of these two rules when, in particular, the blade, or the cylinder itself, is a line;

Figure I e gives two schematic views of poly-turbines;

Figure II e shows main drawbacks of supporting means used in Figure I e;

Figure III e illustrates a first embodiment avoiding the previous drawbacks;

Figure IV e shows the geometrical difficulty to be solved for providing a support when connecting the blade structure by the angles of the triangle thereof;

Figure V e shows how, by changing the observation point, a rhomboid seen in steady way may be seen as a dynamical expression of a square;

Figure VI e shows how to transfer this formal realization into a technical solution by making the supporting gear dynamical;

Figure VII e shows schematically the forces obtained by the two present solutions;

Figure VIII e shows the forces produced when the pieces are supported by the edges of the blades would be weaker every second time, but much higher every second time. By dedicating the pumping function necessary to two-steps engines to the weakest way up, provided it is possible to build a poly-turbine reliably supported by these points, a very strong torque is may be obtained, with an angle of attack of 45° at the time of the maximum compression, which obviously makes this poly-turbine compared with any engines;

Figure IX e shows a first method for building a poly-turbine according to an embodiment of the present invention;

Figure X e is a perspective view of the poly-turbine of Figure IX e;

Figure XI e shows a first way to simplify the structure of Figure IX e;

Figure XII e shows a geometrical way to obtain a rhomboid or a flattened oval shape;

Figure XIII e shows how to further simplify the structure of Figure IX e;

Figure XIV e is a perspective view of the embodiment of Figure XIII e;

Figure XV e shows the high forces generated by such an assembly.

Figure XVI e illustrates the use of such a machine as a two-step engine, standard or anti-discharge.

Figure XVII e illustrates t different embodiments realizing a support of the blade structure by the center or by the corners, wherein a rectangle may also be obtained assuming a rectilinear alternating movement, performing on a mobile base, as shown in a); b) shows a structure wherein the support of the pieces is achieved by means of different gears;

Figure XVIII e shows how to complete both gears systems (with internal type supporting gear) located on each side of the turbine, by a continuous crankshaft, the centre connecting rod journal thereof providing a support for complementary positions of the blade structure.

Figure XIX e shows how to complete both gear systems (with external type supporting gear) located on each side of the turbine, by a continuous crankshaft, the centre connecting rod journal thereof providing a support for complementary positions of the blade structure.

Figure I f illustrates a first embodiment of a mechanical lock;

Figure II f shows how a connecting rod journal may be located in a stop position, by using an internal type induction gear;

Figure III f shows a first arrangement of a group of induction gears and cams about a same supporting gear;

Figure IV f shows how this support is achieved, between two blades provided with driving sliding joints, each one being rotataly mounted about the center, in such a way that the sliding joint be engaged in the induction cam;

Figure V f is a perspective view of Figure IV f;

Figure VI f shows how the time to achieve the locking is delayed versus the time when the closest approach position of the blades occurs;

Figure VII f shows a first method for correcting the delay, by considering a three-blade assembly;

Figure VIII f is a schematic view of the two main positions of the cams in function of the time, in a three-blade assembly;

Figure IX f shows an assembly method allowing locating gears in a two-blade system in stop positions at the earliest possible stage;

Figure X f is a schematic view of the positions of the gears and cams during a one cycle of the machine or engine. It may be seen that the ignition is delayed by one eight of cycle at each closest position of the blades;

Figure XI f shows the rotation of the previous system may be cancelled by using an internal gear. This will allow, if desired, to maintain the igniter plugs and the valves at the same place;

Figure XII f shows the cams may be mechanically forced to separate, either by means of an internal or an external cam. Such a way of doing would be of use in an application of the machine as a pump;

Figure XIII f shows different ways of providing the blades with a sliding joint. Here, instead of being rotataly mounted in the centre and in a sliding way on the cam, they are mounted in a sliding way at he centre and rotataly on the cam. The cylinder may not be circular shaped anymore, and an eight figure is achieved in this example. The action of the blades one on the other remains differential. The figure obtained is that of an eight. This figure may be turned into a rectangle by adding a pad at each extremity of the blades, the pad increasing the curves in the corners;

Figure XIV f shows a displacement of the point rotataly connecting the blade to one of the two cams. Here again, the differential action is maintained, but the dynamical point of the blade will be enhanced by a lever effect;

Figure XV f illustrates an embodiment wherein connecting points of the blade are modified and involve one of the two cams;

Figure XVI f shows a thrust obtained due to complementary stops and dynamical actions, by using internal gears as supporting gears;

Figure XVII f shows that similar locks may be achieved by using supporting gears of the internal type. Here again, the force generated by the system is higher since the forces needed for locking are weaker while those required by the dynamics are increase;

Figure XVIII f illustrates a simplified embodiment of the present invention;

Figure XVIII f shows an embodiment increasing the differential feature;

Figure XIX f shows an anti-discharge version of the engine; and

Figure XX f shows how the gases circulate in a standard two-step version of the engine.

### DETAILLED DESCRIPTION OF THE FIGURES

Figure I a illustrates a number of examples of poly-induction engines using poly-inductive semi-transmissions, including a triangular retroactive engine, a post-rotative octagonal engine, a rectilinear reciprocating engine, and a quasi-turbine.

Figure II a is a transverse view of a semi-transmission 4, wherein defective supporting points may be seen. It is to be noted that the thrust on the blade generates an unbalance of the support.

Figure III a shows a first solution, which proves difficult to operate, using two interconnected complementary system. The semi-transmission 4 is provided on each side, which allows a straighter support of the central connecting rod journal and of the other pieces. However, care must be taken to ensure an equal work of the two semi-transmissions by inter connecting them by means such as gears 6, by means of an axis 7 also fitted with gears 7B.

Figure IV a illustrates a first incomplete embodiment of a bridge-type semi-transmission, comprising only the bridge 8; a central axis 9 goes across the bridge, which is well supported on each side thereof by means of pads 10 themselves well supported on the body of the motor.

Figure V a illustrates improvements of the induction gears, which will yield same power and geometrical effects, wherein the induction gears 11 is fitted with a cam 15 rotataly mounted on one of the axis of the bridge.

Figure VI a illustrates a more complete embodiment of the bridge-type semi-transmission with the induction gear 11 and the supporting gear 17. The induction gears are rigidly connected to the cams that drive the connecting rods, blades or other parts of the core of the semi-turbine, or else other driving parts selected according to whether a reciprocating engine, or an anti- or a post-rotative engine, or a quasi-turbine or a differential induction turbine is being built; the cams will be connected to the blade, which will be inserted into the cylinder of the engine.

Figure VI a illustrates an embodiment wherein the semi-transmission is inserted in the blade itself. To that purpose, the supporting gear 17 has been indirectly connected by means of a rigid neck 21;

Figure VIII a illustrates a semi-transmission that leaves the center clear. The central axis stopping at this level, a second supporting means is provided on a neck located behind the supporting gear. For that purpose, the supporting arm may be moved along the gear neck, before positioning the center gear. Then the supporting gear 17 may be rigidly mounted. A reverse method may be used, by mounted this arm about the neck instead. Then the same procedure applies for the second span, where the blade is to be partitioned in order to be connected. An additional arm may be indirectly connected to the connecting rod journal of the crankshaft, so that by means thereof the energy may be delivered outwards again.

Figure IX a illustrates a first use of this type of bridge semi-transmission in an engine of the type wane engine with a rounded cylinder. Here, the race of the blade would prevent the central axis from going across the engine. Therefore, the type of semi-transmission as described herein is required. The blade and its induction gear 11 are rotataly mounted on the connecting rod journal of the bridge in such a way as to couple the induction gear to the supporting gear. In so far as it is desired to transfer the energy from both sides outbound, a neck may be provided between the induction gear and the connecting rod, at what is referred to as the neck of a first connecting rod, to which a second crankshaft may be related by a second connecting rod.

Figure X a illustrates features in a retro-rotative semi-transmission, which allow, once again, to build, in a very balanced way, a triangular engine. Here, the master gear is of the internal type. It will be noted that since no supporting gear of the external type is used herein, the center being clear, the crankshaft may extend on this side without the need of the additional of the previous figure.

In Figure XI a, the blade is now rigidly connected to the induction gear 11, and simultaneously mounted about the supporting axis of the bridge 8. The induction gear 11 is coupled to the master gear or to a supporting gear 17 of the internal type placed in the side of the engine.

Figure I b illustrates a first way of building a triangular engine in a poly-inductive fashion, by using two induction gears working together to activate the blade. Such an embodiment has already been used and discussed in previous works related to poly-induction. First of all, a crankshaft 12 fitted with two connecting rods 14 related rotataly at each end thereof to gears, referred to as induction gears 11, is rotataly positioned in the side of the engine. These gears 11 are mounted in such a way as that each one is coupled to the supporting gear 17, which is of the internal type and rigidly positioned in the side of the engine. Connecting rods journals 7 or cams are then rigidly fitted on these induction gears 11. The blade 18 is then connected to these connecting rods 7 and also semi-rotataly mounted in the cylinder 19 of the machine. The clockwise action (arrow 1) of the crankshaft 12 causes the retro-action of the induction gears 11 (Arrow 2) supporting the blade 18 through their respective connecting rods 7, since they are also engaged to the supporting gear 17. The size ratio of the gears being here of one over three, the blade 18 will rotate in the opposite direction (Arrow 3) related to the crankshaft 12 and will described the triangular shape of the cylinder 19.

Figure II b shows that by using an inversion semi-transmission, retro-rotative engines may be built. Indeed, by using two induction gears, here induced by their center, namely an eccentric member and a central induction gear, the same shapes described by the movement of the blades may be achieved than in retro-rotative engines. This Figure also shows that the retro-rotative characteristics are achieved, including the complete use of the blade surface and the lever effect due to the support on the induction gear.

Indeed, in the present embodiment, which is illustrated herein by means of two main cross sections a and b, it is assumed that a cylinder of a quasi-triangular shape is provided in the body of the engine 20. Then, a free crankshaft, meaning that it does not directly contribute to deliver energy outwards, fitted with an eccentric member, is rotataly positioned in this machine. A blade 18 provided on its side with a gear of the internal type 17 is rotataly mounted on the eccentric member of this crankshaft and inserted into the cylinder. A semi-transmission 4 is then added to the engine, with the purpose of perform a similar work as that played by the induction gears in the first version, i.e. for inversion of the movement of the crankshaft. A first gear 190 of the semi-transmission will then be fastened to the part of the crankshaft extending into the semi-transmission 4.

An inversion pivot gear 16 will then be rotataly mounted in the side of the semi-transmission 4 in such a way as to be coupled with the semi-transmissive gear 190 of the crankshaft. A third semi-transmission gear 5 is also rigidly connected to an axis going across the machine and to the central axis of the crankshaft along a full width thereof, thereby making the main axis (X). On the opposite side, an induction gear 24 of the blade 18 will be rigidly fastened to this main axis (X).

For each gear specific size rations will be applied to yield a triangular engine. In the present case, the logic of the assembly lies in the fact that the blade is to rotate at the same rate, but in the opposite direction, than the eccentric member.

The induction gear, since it is nested into an internal gear two times larger in size, is made to rotate in the opposite direction twice as fast as the free crankshaft in order to activate the gear of the blade at the rate of that of the crankshaft. This explains why the semi-transmission not only inverses the rotation, but also multiplies the rotation rate. The machine operates as follows. When the main axis of the engine rotates (Arrow A), it automatically drives along the induction gears 24 and the semi-transmission gears 5 to which it is rigidly connected.

The induction gear in turn drives the blade 18 in the same direction (Arrow B). Meanwhile, the pivot gear 16 inverses the rotation of the gear of the axis and causes the gear of the semi-transmission (Arrow C) of the free crankshaft 13 and its eccentric member to rotate in a direction opposite that of the blade 18.

The blade, which is submitted to these varied actions, will have described, after a rotation of the crankshaft, the desired triangular shape.

Figure III b illustrates the above-described system while in a way down phase. On the one hand, it can be seen how the thrust on the blade will be all transferred to the main axis directly through a pressure on the induction gear 24 to which it is rigidly connected. On the other hand, the free crankshaft being submitted to an opposite thrust, and besides from the opposite part of the blade 18, will drive the gears of the semi-transmission in such a way that this force will be re-established in the right direction, which is the direction of the initial rotation of the central axis. The retro-rotative forces will thus be controlled into contributing, even in a larger part, to the rotative forces.

Figure IV b is a perspective view of the previous embodiment, showing the features already discussed.

Figure V b shows that this embodiment achieves the properties of retro-rotative engines since an infinity of engines may be built based therefrom, providing off course that the gear ratios are observed in connection to the number of sides of the blades and to that desired the cylinder. However the gears are to be modified to allow the free crankshaft to finalize the action of the blade. In an embodiment comprising a triangular blade for example, the free crankshaft is to complete a quarter active rotation while the blade completes ⅛th of a retroactive rotation. In an embodiment wherein the blade is four-sided, the free crankshaft is to complete a 60° active rotation for the blade.

Figure VI b illustrates a second way of achieving an inversion, multiplying semi-transmission. The two examples displayed herein are believed to be sufficient to illustrate the requirements to be met to build retro-rotative engine.

It will here be assumed that the axis of the free crankshaft ends with a gear of the internal semi-transmission type 100, which rotates clockwise (arrow 101) for example, while the semi-transmission gear of the central axis (X) will end by an external type gear 103. Both semi-transmission gears will be indirectly interconnected since both will be coupled to an inversion-multiplication pivot gear 107. Hence, the pivot gear 107 will be made to rotate in the same direction as the axis of the crankshaft and will invert the direction of the central axis (X) while simultaneously multiplying it.

Figure VII b shows a drawback of the previous embodiment, which results in a deficient compression. Indeed, a yield ratio of 1 for 3.5 is observed.

In order to correct the shape of the cylinder, a target would be on the one hand that the blade reach deeper into the side of the cylinder during the compression 38, and on the other hand that the side of the cylinder be less doming 38b, i.e. maintained in a closer contact with the blade.

Figure VIII b illustrates a further embodiment of the invention, wherein the semi-transmission elements are cancelled and a poly-induction is provided with the aim of achieving the previously mentioned objectives. In this embodiment, a crankshaft 12 is fitted with a standard connecting rod journal instead of an eccentric member. The blade 18 is rotataly positioned on this connecting rod journal 14, together with the induction gear 11 that is fitted thereto. The type of assembly for connecting either the crankshaft or the blade and its gear is not considered here. The induction gear is then coupled to a supporting gear of 17 the internal type, which is here 3 times larger in size, and located in the side of the engine 20.

As shown in Figure IX b this machine operates as an engine as follows. During the explosion, as in almost any engine, a between cycle time occurs. Indeed, since the induction gear 11 and the crankshaft 12 are centered, the thrust is equally distributed on the blade 18. However an important aspect to investigate is what happens during the deconstruction of the system.

In this assembly, since it is a retro-rotative engine, even the back effect of the blade is, as may be seen, dynamical. The front effect, here on the crankshaft, drives the crankshaft into a direct rotation. The back effect is enhance by a lever effect, since the blade 18 is connected to the internal supporting gear 17 through the induction gear 11, which is rigidly connected to the blade, and pushes like a lever on the connecting rod journal 14 of the crankshaft, thereby forcing it also, in an additive way, to move down.

This makes the engine very powerful. Compared to rotative engines for example, there is an added energy and added thrust instead of a decrease. Obviously, as previously, depending on the selected gear ratio, the number of sides of the blade and of the cylinder will have to be adjusted.

In the case of a gear ratio of one over four, a triangular blade acting in a four-sided cylinder will be selected. In the case of a gear ratio of one over five, a square blade will be selected for a five-sided cylinder, and so on.

Finally, it will be noted that the target of obtaining an increase in the compression ratio is achieved since the blade still has an eccentric member connected to the connecting rod journal of a crankshaft. Therefore, the blade, as previously mentioned, is allowed to move further from the flat regions during the explosion and deeper in the corners between two explosions.

This figure therefore illustrates the desired result of such an embodiment, namely the improved compression. As previously, it will be shown that the retroactive characteristics are maintained in such an embodiment.

Figure X b shows that it is even possible to supercharge this system by using an improved design of the blades. Indeed, in a limit case of the last method, the blades will be allowed to move so far into the cylinder that they will have to be shaped in a manner more adapted to the curvature of the cylinder, which is itself a result of the path of the extremities of the blade.

Figure XI b shows that a range of such engines may be built.

Figure I c illustrates examples of poly-inductive engines, the first one being of the retro-rotative type, and the second one of the post-rotative type. In particular, it is shown that in each case, induction gears, which are inversion gears in relation to acceleration induction gears, are used. In these engines, a crankshaft 12 provided with two opposite fittings 20 is rotataly mounted in the body of the engine 20. A gear referred to as a supporting gear is positioned in the side of the machine. The first supporting gear 17a is of the internal type, while the second 17b is of the external type. Gears referred to as induction gears 11 are connected to each end of the fittings of the crankshaft in such a way as to be coupled to the supporting gear 17a, 17b. The induction gears 11 are provided with connecting rods 7 or cams, to which the blade 18 is connected.

In Figure II c is illustrated a generalization of these engines, which points out geometrical similarities and differences of these two categories. As previously described in a patent application dealing with the matter by the present inventor, two infinite series of engines may be built following the side rule, which states that in any retro-rotative poly-rotative engine, the number of sides of the blades 18 is inferior by one to that of the cylinder 19, while in post-rotative engines, the number of sides of the blades 18 is greater by one to that of the cylinder 19.

Figure III c illustrates three specific ways of building retro-rotative engines as known in the art. One of these (Figure IIIc b) is equivalent to what has been previously described. The other solutions use a semi-transmission (Figure IIIc a), and a retroactive direct off-center assembly (Figure IIIc c) respectively.

Figure IV c illustrates how the forces act on the entire blade, for example in the second figure above, since the retro-active forces are successfully monitored into contributing to the positive deconstruction of the system, without energy loss, and even with a lever effect. Indeed, it may be seen hat the forces on the blade directly cause on the left hand side (Arrow G) the crankshaft 12 to move downward (Arrow D), while these same forces simultaneously act on the induction gear coupled to the blade gear and make it rotate to the right (Arrow E), in a direction opposite that of the crankshaft. This movement in turn is inverted by the semi-transmission, as is well understood by now, and further transferred in the right direction to the crankshaft 12. Therefore, the crankshaft is submitted to an addition of the forces (Arrow F).

Figure V c shows advantages of mounting a post-rotative engine in a poly-rotative way, hence its name. Although not as powerful as retro-rotative engines, the resulting engine has however the ability to cancel the retro-rotation effects, even without controlling these effects. Indeed, during the way down, the thrust T on the connecting rod of the induction gear is automatically compensated by a counter-thrust CT of the connecting rod journal of the crankshaft 12. The entire thrust RT on the back part of the blade. Moreover, the thrust of this part acts on a connecting rod journal which torque is increased due to its off-center position and its outbound acceleration (Arrow H). Consequently, this engine is more powerful than a rotative, simple dynamical induction engine for example, as will be apparent in the following figure.

Figure VI c shows that the current set up of rotative engines yields a very unsatisfactory use of the explosion forces having regard to the embodiment using three poly-inductive blades already commented.

Indeed, a first drawback of this type of engine is that the thrust on the back part of the triangle blade of the engine generates a counter-thrust on the, which opposes the rotation of the engine. Thus, not only almost one third of the energy is lost, but also more than the second third and a half of the central part of the blade are wasted, seeing the additional lever effect that has to be compensated in order to cancel the backpressure. Therefore, only as little as 25% of the energy remains positively available from an initial energy, which is, as will be shown later, already reduced. For this remaining quarter, there is only a weak torque, since the side of the blade tends to follow, although at a reduced rate, the movement of the crankshaft. In a reciprocating engine for example, a way down of the connecting rod journal of the crankshaft at 60° as in the present case already causes an angle with the connecting rod of about 90° (angle α). Here, for a similar down angle of the crankshaft, the angle is of only 30°. It is to be noted however that the blade has to force the crankshaft into moving down faster that it does itself but in a bad way. Finally, it must be noted that the crankshaft moves in a wedging like manner (Arrow I), which very remotely causes a friction at the back thereof (Arrow J). Considering all these features, it is easily understood that not more than 20% of the explosion force is recovered in such type of engines, and that the efforts spent on the turbo-compressor are also simultaneous efforts to slow it down, since an explosive power is created which needs unfortunately be dissipated in the most part thereof.

Figure VII c explains the main differences existing between retro- and post-rotative engines concerning the direction of rotation of the crankshaft in relation to that of the blade, depending on whether these are connected to the inversion gears or to the acceleration gears of the poly-inductive machine. In this figure the main difference between retro- and post-rotative engines shown is that, in both cases driven by gears, in the former ones the blade 18 rotates in an opposite direction (Arrow K) from its crankshaft 12, while in the latter the blade moves in the same direction (Arrow L).

Figure VIII c shows that the retro-rotative effect may not be directly achieved in a post-rotative engine, by using a retroactive assembly comprising a three-sided blade. It is seen that, following the side rule, presented in the present inventor's application dealing with a generalization of poly-inductive engines, a square-shaped cylinder is obtained, and that the blade would dig into the cylinder otherwise.

Figure IX v illustrates a different way of analyzing the movement of the blade with regard to that of the crankshaft, wherein the blade movement is not considered from the point of view of an external observer but from that of an observer positioned on the crankshaft itself, and comments on consequences of such point of view. Interestingly, from the point of view of an observer positioned on the crankshaft instead of from that of an external observer, one can see, after a quarter rotation of the crankshaft, that the reference point located on the side of the engine has moved to the left by 90 degrees 35, and, even more important for the present matter, that the blade has moved to the left thereof, i.e. backwards, by 45 degrees. This means that the blade is active in relation to the body of the machine, but also retroactive having regard to the crankshaft.

Another way of figuring this is to realize that if the blade did not move backwards, it would remain at a constant angle of 90 degrees with respect to the crankshaft 12, which is not (position in dotted lines).

Figure X c illustrates a first embodiment of a retro-rotataly mounted post-rotative engine. The principal is as follows. It is a known fact that the blade is retroactive, not in relation to the engine, but in relation to the crankshaft. Then, it will be assumed first of all that the crankshaft is rotataly mounted in the engine without any eccentric member, this crankshaft also being used as a central axis of the engine. Moreover, this crankshaft is designed so as to be provided with a rotataly mounted pivot gear 39. A secondary crankshaft 12b fitted with an eccentric member as well as, on a side thereof, with a corner gear 42, is placed about the axis so that its gear is coupled to the pivot gear 39. On the central axis, a second gear 43 is then rotataly mounted in such a way as to be also connected to the pivot gear 38. This induction gear is rigidly connected to a straight gear 45, which is in turn coupled to the internal gear of the blade. Thereby, in a simpler way, a first inversion semi-transmission is then built inside the blade, which allows invert the blade in relation to the crankshaft. A blade 18, provided in a side thereof with an internal crankshaft, is rotataly mounted on the eccentric member of the crankshaft in such a way that the internal gear of the blade be engaged to the induction gear of the inverter.

So far, there is thus provided a system, which allows inverting the movement of the blade with respect to that of the crankshaft. But now it is known that in a post-rotative engine, even when it is known to act in an opposite direction in relation to the crankshaft from the point of view of the crankshaft, the blade may be considered as acting in the same direction if seen from an external point.

Therefore, certain elements of the engine have to be connected in such a way as to keep one of them, for example the crankshaft, in a given direction, while inverting again the other so as to re-establish the same direction. In fact, this means that a semi-transmission must be added, which, together with a pivot, will inverse again one of the two elements, i.e. either the blade or the crankshaft. That is the reason why a second gear 47 is added to the crankshaft, this second gear being coupled to the inversion gear of the semi-transmission 48. This latter gear is rotataly positioned in the semi-transmission body 49. A third gear of the semi-transmission 50 is rigidly mounted on the central axis in such a way as to be coupled to the inversion gear. By operating the assembly, the blade, with respect to the eccentric member of the crankshaft, will be submitted to the differential of the movements induced by the pivot of the crankshaft on the eccentric member as well as on the internal gear provided on the blade.

A first consideration of such a double-inversion system will doubtless be that, by inverting twice the system, since −(−5) is equivalent to 5, is that it only consists of a more complicated manner of achieving an obvious result. A further analysis will show that that is not the case.

Figure XI c shows that, in such an engine, a complete control of the thrust forces of the blade and of the deconstruction of the system is achieved. During the “way-down rotation” of the blade, the backward thrust, in retroaction, drives the free gear mounted on the axis (X), which in turn drives the internal pivot gear 53 of the crankshaft, which consequently activates the gear 54 of the crankshaft. On an opposite side, the blade acts on the crankshaft, making it rotate in the same direction as previously. Then the rotation is transferred to the external semi-transmission gear of the crankshaft, and then further transferred to and inverted by the pivot gear 56 of the semi-transmission, which in turn drives the transmission gear of the axis, thereby delivering, as a single energy, the accumulated thrust outbound, but, in this case, in a direction opposite that of the crankshaft.

Therefore, this engine is effectively retro-rotative, with a blade thereof acting so as to be receptive all the thrusts and the counter-thrusts, and an output axis thereof being in a reverse direction from this blade. Such an assembly definitely allows more power than conventionally used ones, and this mainly because it provides a cancellation of the power losses as already discussed, besides generating positive lever effects that multiply he power. The above is evidence of the difference between double inversion of numbers and double inversion in the field of mechanics.

Figure XII c is a perspective view of the engine of Figure X.

By using a semi-transmission that simultaneously inverts and multiplies by two the rotation speed of the induction gear, an by reducing by half the size, the equilibrium is maintained, but now in a double-inversion mechanism comprising a double dynamical support, which is what is needed.

Therefore, in the present case, a crankshaft fitted with a connecting rod is inserted in a part. As previously, this is a free crankshaft, in that it will not draw the energy outbound. One end of this crankshaft stops in the semi-transmission where it is rigidly connected to a semi-transmission gear 50. A blade 18, provided with an internal gear on a side thereof, is positioned into the cylinder of the engine 20 in such a way as to be rotataly mounted on the eccentric member of the crankshaft and so that at the same time its gear be coupled to the induction gear 52 of the central axis. An inversion pivot gear 48 is rotataly mounted in the side of the semi-transmission so as to be coupled to the gears of the crankshaft and of the central axis of the engine. A central axis of the engine going across the crankshaft and fitted at each end thereof with a transmission gear 51 and a blade induction gear 11 respectively, is rotataly inserted into the engine, in such a way that its transmission gear be coupled to the transmission pivot gear and that its induction gear be coupled to the blade internal gear.

For each gear, the size ratio thereof with respect to the other gears is indicated. Different gauging may be possible. Here, the gauging was made to allow the induction gear, instead of being still, to rotate twice as fast. However, the induction gear is twice as small in size than if it had been still. A post-rotative shape is then allowed, although provided with a retro-rotative power, which is what was sought.

As previously, although in a simplified way, the present machine, during its expansion, makes an efficient use of all the thrust forces. Post-active forces are diverted onto the eccentric member of the crankshaft (Arrow M), which in turn leads them to the pivot gear of the semi-transmission 71. This pivot inverts these forces (Arrow N) and transfer them, once inverted, to the central axis of the machine (Arrow O), which, since it is rigidly connected thereto, passes them on to the induction gear. Meanwhile, the induction gear supports the retroactive downward force of the blade (Arrow P), and these two sets of forces instead of cancelling, add together in a retroactive way, which is what was intended.

Instead of using a gear which simultaneously inverts and reduces as previously, these functions may separated by using a pivot gear dedicated to balancing, inversion being produced by an internal gear. Therefore, the end of the crankshaft is assumed to be coupled to a pivot transmission gear of the internal type. This gear is coupled to the pivot gear, which, receiving the inverted movement from the internal gear, passes it on to the gear of the central axis.

Figure XIII c illustrates a combination allowing cancelling the semi-transmission, by using two internal gears engaged on a same pivot axis mounted on the fitting of the crankshaft. The previous structures have proved that inversion by means of internal gears requires fewer pieces. The present figure shows that even the semi-transmission could be removed. Here, an axis 80 fitted at each end thereof with an induction gear 81, 82, is rotataly mounted on the eccentric member of the crankshaft of the machine, at a height for example. The gear ratios will be carefully selected to yield a smoother incidence of the induction gear on the connecting rod by a desired angle, depending on the engine to be built, i.e. a square engine or an octagonal engine etc.

One of the gears is coupled to an internal gear placed in the side of the bloc 83, while the second one is so positioned as to be coupled to the internal gear of the connecting rod 84.

The operation of the machine will be such that during the rotation/way down, the post active force (Arrow Q) will drive the crankshaft forward. As for the retroactive forces, they will act into tipping backwards the induction gear (Arrow R), which, transferring this force to the induction gear 88 on the side, will lock onto the stationary internal gear 89 and will act as a lever on the crankshaft. This crankshaft will thus be submitted again not only to the addition of the forces but also to added lever forces (Arrow S).

Figure XIV c illustrates an off-center embodiment of the present invention, which allows supercharging the system. In this embodiment, the internal gears are differently coupled to the axis of the connecting rod journal. There is still here an axis going across the eccentric member of the crankshaft and, at each end or on a given side, induction gears. In contrast with the previous figure, the internal gears 100 are superimposed, thereby allowing an enhanced off centering (axis 101).

Figure XIV c shows a simplified way to perform the present invention by using one single internal gear loosely positioned in the machine. As is well known in the field of engines, a most important step following the finding of a new way to tackle and to solve a problem is to obtain the most simplified solution thereto. Here the two inversion semi-transmissions used hereinbefore, one of which was located inside the piston and the other in the semi-transmission, are embodied by a specific layout of three gears.

A supporting neck 110 is rigidly positioned in the side of the machine. Then, a first part of the crankshaft 111 is mounted on this neck. A supporting gear of the external type 112 is also mounted on this neck. This gear 112 is then coupled to a second gear of the internal type 113, which rotates thereabout as a hoop. Since this latter gear 113 is not rigidly related to any element of the machine, an anti-sliding means 114 may be provided thereabout and on each side thereof so that it adequately rotates about itself. Then a blade 116 is rotataly mounted on the connecting rod journal 115 of the crankshaft, this blade being fitted with an induction gear 117 rigidly mounted thereto in such a way that this gear is coupled to the opposite part of the internal gear 119. Finally, the crankshaft 111 may be further maintained by connecting the complementary part 120 thereof. Obviously, a different assembly procedure may be selected, for example by first separating and then assembling the blade and its induction gear so as thus maintaining the crankshaft as a single piece. The present only aims at showing an alternative, which may then be varied. It will lastly be noted that a neck may be located between the connecting rod and its gear, which allows connecting the arm of a tracking crankshaft. Such a method provides an output to the outside for the fire for example. A number of other methods are possible, which is why this will not be discussed further herein.

Figure XVI c shows the energy distribution during expansion of such a system. Given a three-sided blade, the external gears will have to be of a same size, which is twice as smaller as that of the internal gear.

On the one hand, the post active thrust (Arrow 121) on the blade then will first be transferred on the eccentric member of the crankshaft (Arrow 122). On the other hand, the retroactive thrust on the blade (Arrow 123) locking onto the internal gear 124, this gear itself locked onto the supporting gear 125, will act as a lever effect (Arrow 126) into the connecting rod journal of the crankshaft, thereby driving it in the same direction as that of the post active thrust. Once again, instead of cancelling one another, the forces not only add but also multiply. This retroactive embodiment is about 400 times more powerful that mono-inductive version.

Figure I d illustrates two different embodiments of poly-induction engines, wherein the first one is retroactive with a triangle cylinder, and the other one is post-rotative with a square blade. Since the assembly of these engines has been previously described in detail, only a brief overview of the differences between them will now be given. In the triangle engine 20, two induction gears 11 are coupled to a supporting gear 125 of the internal type and thereby drive the blade 18 through respective connecting rod journals thereof (Arrow Y), as well as the crankshaft although in an opposite direction (Arrow U). In the second machine, the induction gears 11 are instead coupled to a supporting gear of the external type. Through respective connecting rod journals thereof, they drive the blade 18 (Arrow V). and, at the same time the crankshaft and its connecting rod journal, this time in the same direction as that of the blade (Arrow W).

Figure II d shows a series of retro-rotative machines, which all satisfy the side rule. Indeed, as may be seen, a blade 18b with two sides is associated with a three-sided cylinder 19b. A three-sided blade 18d is associated with a four-sided cylinder 19c. A four-sided blade 18d is associated with a five-sided cylinder 19d, and so on.

Figure III d is a series of figures corroborating the side rule when applied to post-rotative machines. In this series, the first illustrates a post-rotative machine which blade has a number of sides superior by one to that of the cylinder. A two-sided blade 18e is therefore associated with a one-sided cylinder 19e. In the following, a three-sided blade 18f is associated with a two-sided cylinder 19f. Then, a four-sided blade 18g is associated with a three-sided cylinder 19g, and so on.

Figure IV d compares these two types of engines assuming that each is provided with a two-sided blade. It may be seen that, in the case of the retro-rotative engine, the cylinder 19 has three while, for the same blade 18, the cylinder 19 of the post-rotative engine has one side, which obviously has to be understood in the context, since here in such a limit case, the cylinder is fully folded upon itself.

Figure V d is a comparison of these two types of engines assuming that they both comprise a same triangle cylinder. In the case of the retro-rotative engine, it may be seen that the blade has two sides, whereas in the post-rotative engine, it has four sides.

Figure VI d shows, in the simplest poly-inductive embodiment, the gear ratios to be observed between the induction gears 11 and the supporting gear 125 in order to achieve the desired number of sides of the cylinder. In retro-rotative engines, the size of the supporting gear 11 (here 3) divided by the size of the induction gear 125 (here 1) equals the number of sides of the cylinder 19, which is here 3 (21). In the case of post-rotative engines, the size of the supporting gear 11 (here 2) divided by that of the induction gear 125 (here 1) equals the number of sides of the blade 18 (here 2).

Figure VII d shows borderline cases of the side rule. In the case of retro-rotative engines for example, when the blade ideally reduces to a point, the cylinder reduces to a line 25, which is what occurs in engines with rectilinear connecting rods. In a second example of a borderline case, there is s a quasi similarity between retro- and post-rotative machines. Indeed, a retro-inductive machine provided with a one-sided blade yields a cylinder having a double arc shape 26, very similar to that of a post-rotative machine comprising a two-sided blade associated with a cylinder having an arc side.

Figure I e gives two schematic views of poly-turbines, comprising the two main mechanical supporting means already described in the present application. Briefly stated, a blade structure 180, comprising four blades 18 interconnected by their extremities 183, is inserted into a cylinder 19 of the engine 20.

In the first case, a supporting structure comprising two induction gears 11 provided with connecting rod journals or cams 7 are each rotataly mounted on a fitting 40 of a crankshaft 12 and coupled to a supporting gear of the external type 125. Connecting rods 184 connects the cams to a complementary connecting point of the blades 182.

In part B of the Figure, the induction gears 11 are this tine connected to a supporting gear of the internal type 130. Moreover, the connecting rods here connect the cams 15 to a center of the blades.

Figure II e shows the main drawbacks of these two supporting means. In relation to the first structure, it may be seen that the gear structure varies in time in shape between a rhomboid and a rectangle. This structure is unsatisfactory since it generates two rotations of the blade structure, which differ based on whether the square is supported on the right or on the left.

In the structure supported by means of an internal gear, the main drawback stems form the fact that the shape described by the cam of the gears is that of a square, when the needed shape is of the rhomboid type or that of a flattened oval.

Figure III e illustrates a first way of setting up a structure avoiding the previous drawbacks by a different layout of the angles of the supporting structures in relation to the angles of the blade structure, and moreover, by an indirect interconnection thereof by means of blades mounted for that purpose. As may be seen, such an embodiment allows the use of only two supporting points.

In this case, two intermediary supporting connecting rods of the blade structure are provided with driving sliding joints 190 are rotataly mounted on the axis of the machine 18 in such a way that their sliding joints are engaged on the induction gears 11. Each end of these connecting rods is in turn connected to a centered position of the blades 18. The machine will then operates as follows. Since the sliding joints cancel the vertical aspect of the movement of the cams, a right angle is formed between the cams when the cams are complementarily positioned by two, respectively at their most closed position and at their more opened position 220. Hence, the blade structure will be in a square configuration 230.

A quarter rotation after, the induction cams will found themselves, successively, each at a closest 240 and at the more remote 250 position from the preceding cam and the following cam respectively. Hence, the blade structure will be in the desired rhomboid configuration.

Figure IV e shows the geometrical difficulty to be solved for providing a support when connecting the blade structure by the angles of the triangle thereof, i.e. the difficulty involved in producing a rectangle inside an already built square. It is to be admitted that an efficient structure for supporting the pieces by using a gear of the internal type must describe the shape of a rectangle.

Figure V e shows how, by changing the observation point, a rhomboid seen in a steady way may be seen as a dynamical expression of a square. Provided it is possible to look at the movement of the pieces from a reference point located in the center of the system, and rotating about itself at a rate twice lower than that of the system, it is seen that the formation of a rhomboid corresponds to the delayed dynamical formation of a square.

From the first point of view, the point a1 is a given point of the chamber of the cylinder and the point b1 is a give point on one of the blades of the blade structure. The following illustrations show the movement of the blade structure and of the predetermined point from the point of view of a moving observer, which yields, from the point of view of the observer, to the formation of the desired square.

Figure VI e shows how to transfer this formal realization into a technical solution by making the supporting gear dynamical an inversion semi-transmission. As for example the ones used previously in the retro and post rotative engines, will be sufficient to drive the supporting gear into a direction opposite that of the induction gear, in a ratio of one height of rotation for the supporting gear versus one half rotation of the induction gear, in the present example. The supporting gear 130, which now ends by a semi-transmission gear 600, may be rotataly mounted in the machine (Arrow Ω), in such a way as to be coupled to a pivot reducer gear 62. This gear 620 in turn is coupled to a semi-transmission gear 630 positioned on the crankshaft, which supports, on an opposite end hereof, the induction gears 11 having cams 15 supporting the blades 18. It will be appreciated that four cams 15 are used so that the structure blade is devoid of any autonomy.

Figure VII e shows schematically that the forces obtained by the two present solutions are retroactive. The forces (Arrow 6) on the blade act on the crankshaft of the induction gears. On an opposite side, forces submitted to the induction gears themselves will drive them into an action (Arrow 67), which, inverted by the semi-transmission, will be positively transformed on the crankshaft where it will be added (Arrow 68).

Figure VIII e shows that, as previously mentioned, as few as two connecting points 200 may be sufficient to support the pieces, which would allow to reduce the number of pieces necessary in the assembly of the machine.

The advantage and weak point of such a method would be that the forces generated in the case of a support of the pieces provided by the corners of the blade would be weaker every second time, but much larger every second time b. Indeed, every second time, during the explosion, the cam would not rise completely, but then the following time, since the way down would then be already started, a very high torque would be created. By dedicating the weaker rise to a pumping aspect required in two-step engines, provided a reliable poly-turbine could be built based on these supporting points, a very high torque would be achieved, with an angle of attack of 45 degrees during the maximal compression, which obviously makes such a poly-turbine advantageous compared with any engine. As previously mentioned, supporting the blades by their extremities might be satisfactorily achieved by as few as two connecting points, which would allow to reduce the number of pieces necessary in the assembly of the machine.

Figure IX e shows a first method for building such poly-turbine. Two driving rods of the blade structure are each connected to the connecting rod journal of a crankshaft, while simultaneously being submitted to a directional supporting means, which rotates in the opposite direction. In such structure, two connecting rods 184 connect the connecting rod journals 14 of a crankshaft and the opposite connecting points of the blade structure. A rotative piece inducing the orientation of the connecting rods 201 is rotataly positioned in the body of the machine, in such a way that a movement thereof is opposite that of the crankshaft (Arrow 73). Such inversion may, as previously, be performed once per rotation by a semi-transmission connecting, through a pivot gear, the gears of the crankshaft and the rotative pieces inducing the orientation of the connecting rods.

Hence, these pieces being activated, the blade structure will be totally submitted to a movement of the connecting rods and will have the desired motion.

Figure X e is a perspective view of the previous one.

Figure XI e shows a first way to simplify this structure, by discarding the pieces more liable to be submitted to friction and instead using only gears means, which are in the present case strictly of the external type. It will be here assumed that the connecting rods, connected to the blade structure, are rigidly mounted on one of the induction gears 11. Then these induction gears are mounted on a supporting gear of the external type 125, which is itself dynamical. By means of a semi-transmission 400, this dynamical gear will be set to rotate in a direction opposite that of the supporting gear in a ratio, given the same size, of about three over one. Such inversions may once again be achieved by different layouts of inversion semi-transmissions. Figure XI e b) shows the movement of the pieces during one rotation of the machine a), b), c).

Figure XII e shows a geometrical way to obtain a rhomboid or a flattened oval shape, using internal gears. When considering a point outside of the circumference of the external gear 401, it will be noted that, after two complete rotations of the external gear inside the internal gear, the shape described by this point positioned point outside of the circumference of the external gear is a rhomboid, which is what is desired with the purpose of involving the external surfaces of the poly-turbine.

Figure XIII e shows how to further simplify this structure, based on these geometrical teachings, by building an equivalent of Figure XII E using now supporting gears of the internal type. In the previous figure, the supporting gear was active and beside in a direction opposite that of the crankshaft that supports the induction gears. Here, the friction observed in the previous figure is cancelled. However, the number of pieces remains quite high, since a semi-transmission is used. In the present figure, it is shown how to achieve a similar motion of the pieces, by using instead induction gears, also rigidly provided by connecting rods, but this time connected to supporting gears of the internal type. Figure b shows schematically the motion of the pieces during a quarter rotation. This time, diving rods are rigidly mounted on induction gears coupled to a gear of the internal type.

Figure XIV e is a perspective view of this last embodiment.

Figure XV e shows the very high forces generated by such an assembly. First, it may be seen that at the time of explosion, when the compression is the strongest, the attack angle of the crankshaft is of 45 degrees (angle β) instead of being of zero as in conventional engines. Then, it may be noted that a same explosion connects the chambers 91, or else two simultaneous explosions flatten the square of the blade structure, which will not result in a thrust on the connecting rods but in a much greater pulling force, which will draw then outwards (Arrow 92). Lastly, it will be noted that these forces are not direct forces, but rather generated under a lever effect, which drives the crankshaft into a supported position onto the internal supporting gear 93.

It is here believed that a greater torque is difficult to achieve with such a machine. Indeed, while certain engines, such as rotative engines, only deliver one fifth of the power generated by explosion, the present turbine delivers this power in its entirety, multiplied by the torque and even more increased by the lever effect as well as by the pulling effect. This turbine therefore might be several times more powerful than conventional engines as far as a ration gas used versus created power is concerned.

Figure XVI e illustrates the use of such a machine as a two-step engine, standard or anti-discharge. The gas inlet is in charge of the part of the blade submitted to a counter-torque during its more compressed phase (Arrow 100), to inject the clean gases into the following chamber (Arrow 110) before back blasting the burnt gas (Arrow 111). A quarter rotation later, new clean gas will be compressed and processed, by he blades having an improved torque, while the complementary blades will be receiving in turn clean gas. In the case of anti-discharge machines, two blades or partitioned blades may be used.

Figure XVII e illustrates three different embodiments realizing a support of the blade structure by the center or by the sides. In a) it is shown to use a master crankshaft both for receiving the direction connecting rods and for supporting the induction connecting rod journals, in such a way that it is activated by the induction gears and the supporting gears and controls the opening connecting rods of the blade structure. In b) it is shown how to achieve such a structure using internal gears located in the blades. The idea of such an embodiment is to trigger the alternating motion of the connecting rod journals of the induction gears of the blade structure, during the circumferential movement of a wall of the crankshaft provided with two supporting gears, this alternating motion making successively the connecting rod journals get in and get out from the gears, thereby performing the desired rectangular shape. The induction gears and cams are rotataly mounted on subsidiary crankshafts, which are coupled to master induction gears coupled to a main supporting gear.

Figure XVIII e shows how to complete both gears systems (with internal type supporting gear) located on each side of the turbine, by a continuous crankshaft, the centre connecting rod journal 501 thereof providing a support for complementary positions of complementary connecting rods of the blade structure. Here, the crankshaft connecting both semi-transmissive structures is provided with additional connecting rods journals 500 connected with connecting rods 1000, which are related by an end thereof to the complementary connecting points of the blade structure. Such a layout allows to multiply the strength of the explosion, b) the induction gear still working as rotation pivot, although the induction is now rather located in the front and alternatively in the back thereof.

Figure XIX e shows how to complete both gear systems (with external type supporting gear) 800 located on each side of the turbine, by a continuous crankshaft, the centre connecting rod journal 500 thereof providing a support for complementary positions of the blade structure. Such an embodiment yield a much increased explosion, the induction gear still working as rotation pivot, although the induction is now more effective in the front and alternatively in the back thereof.

Figure I f illustrate a first literal embodiment of a mechanical dynamical lock. The same embodiment will be described in relation two transverse versions thereof (Figures IF a and b), for a better understanding. In Figure I F a), gear referred to as a supporting gear 2000 is assumed to be rigidly fastened to the solid part 1000. This gear is provided with a passageway 300 in its centre for accommodating the central axis of a crankshaft 440 of a crankshaft rotataly inserted in this centre of the machine, across the supporting gear. This fitting of the crankshaft is itself provided with a passageway 614 for accommodating in turn the central axis 714 of a gear, referred to as an induction gear 800. A length of the arm of the crankshaft is determined and adjusted so that the induction gear is coupled o the main gear. The central axis of the induction gear is also provided with an arm and a connecting rod journal 1000.

The structure may also be assembled with a cam, as generally described in the present inventor's application dealing with the matter, but it is believed that the use of a connecting rod as described here makes the demonstration clear and more obvious.

From a dynamical viewpoint, it is observed that when the crankshaft rotates in a clockwise direction, the induction gear is submitted to the effect of this rotation and is set to rotate itself in the same direction as the crankshaft. Inversely, when the connecting rod journal of the induction gear is acted upon rotataly, the rotation of the gears is triggered and consequently that of the main crankshaft. It should be repeated here that the rotation of the crankshaft happens only when action rotataly upon the induction gear. Such being the case, it is to be noticed that the thrust of the gases on the pieces is not rotative but rectilinear. Therefore, if the pieces are acted upon by way of a thrust, as compared to the action of the gases, it will be appreciated that things will occur differently. In given phases of deployment of the system, a resulting locking effect may even be generated by the thrust on the induction connecting rod journal.

Figure I f b) intentionally shows a different position to better illustrates such locking effects. In such position, a thrust produced backwards (Arrow 14) on the induction connecting rod journal 1000 of the induction gear will drive or tend to drive the induction gear into a clockwise direction. Since the centre of this gear is related to the arm of the crankshaft, this rotation will trigger the rotation of the crankshaft, this time towards the front. Such a thrust toward the front of the crankshaft will in turn also drive the connecting rod journal of the crankshaft and the axis of the centre of the induction gear towards the front. Such a move forward is exactly opposite that of the initial thrust. The greater the initial thrust, the greater the counter-thrust, i.e. the resulting thrust occurring in a reverse direction. It may be even said that the counter-thrust, due to the lever effect created by the induction gear, will be superior to the initial thrust.

Figure II f shows how to obtain a similar kind of locking effect by using this time a supporting gear of the internal type. However, as a particularity, it will be noticed that the connecting rod journal 1000 now stands in the upper part of its rotation when in a locking position. In the previous figure, it was observed that, when a thrust 1400 is produced on the induction connecting rod journal, in a given position of the system, the pivoting action of the induction gear results in a thrust on the main crankshaft, which turns into a counter-thrust 16, which is either of the same order or greater that the initial thrust. The system may therefore be operated this way.

Figure III f show schematic views of the initial set up of the gear means of the engine. In order to be able to connect the blade, cams 17 are here substituted for the connecting rod journals of the induction gears. In future embodiments, these cams will be connected two by two to the blades. The gears will be positioned so that two among them have their cams located in their more remote position (D1) while the two cams of the opposite complementary gears will be set in their closest position (D2). When in their locking position, the cams will be said to be locking, as opposed to the complementary cams, which will be referred to as dynamical. The deployment of the system will cause, after a quarter rotation, the cams to be in a position described in Figure III f b), which reminds the shape of a rectangle. The two following quarter rotations will successively repeat these positions of the cams.

Figure IV f shows a similar more achieved semi-transmissive configuration, wherein blades 2100 have been added. These blades, which are provided with induction sliding joints 2300, are semi-rotataly mounted about the central axis of the crankshaft, in such a way that the induction sliding joints 2300 are engaged in the induction cams 1700. The cams will act on the blades so that they will alternatingly come close together and drift out one from the other. Such a mounting of the cams may be preferably performed by means of pads that are innerly round and externally flat, thereby allowing a good match with the sliding joint as well as will the connecting rod journal. The figure shows the effect of the thrust of the blades. It may be observed that the thrust, through the blade, results in a locking effect on the gear. The thrust 3100 on the complementary blade will instead have a dynamical effect thereon, through the cam gear in a dynamical position, which will result in a dynamical urge of the engine as a whole.

The differential action of this dynamical thrust and the locking effect will provide the energy require to activate the engine. That is the reason why this engine is called an energetic engine with a differential action. Obviously, each cam and blade will play alternatingly the role of locking cam, locking blade and dynamical cam or blade. The blade will extend to a maximum, thereby closing the spaces located in their complementary sides.

Figure V f is a perspective view of the machine, which was previously explained wherein the two blades 2100 act one against the other, the first one working as a dynamical lock allowing the thrust on the second one to have a dynamical incidence. The supporting gear 2 is mounted by a rigid neck in a side of the engine 20. The central axis (4000) of the crankshaft 5000 is rotataly inserted into the central passageway of the gear. This crankshaft is provided with four crankshaft fittings. Each fitting is in turn provided with a connecting rod journal on which an induction gear provided with an induction cam is rotataly mounted. The resulting structure is mounted in such a way that the induction gears are coupled to the supporting gear in the way previously described, the opposite gears being either completely out or completely in. Two blades 2100 each provided with a an induction sliding joint 23 are then assembled together on such a way that they are at the same time engaged on the induction cams 1700 by their induction sliding joints and semi-rotataly engaged by their centre with the central axis of he crankshaft. The present system is displayed in an expansion phase. It will be noticed that the opposition of the blades 28 causes the differential induction of the system.

Figure VI f shows the main drawbacks of the previous embodiments. It is shown that the time when the locking effect becomes effective is rather late after the ideal time of explosion, which is the time of minimum distance between the pieces as shown by a dot line. It must be waited until the system has its cam pass the perpendicular level (Arrow 39) where the two contrary forces start to oppose before causing the explosion. Such a delay causes an early opening of the dynamical and consequently a loss of compression since the blades have already started to get apart (Arrow 40). If the explosion is anticipated, a harmless backward effect is produced, and the differential force is then considerably reduced.

Figure VII f shows a first method for correcting this, by using more blades in order to reduce the angles between the cams and allows that the dynamical cam has not yet started getting out when the locking cam enters its locking phase. In the present figure, there are a total of six induction gears and cams 1700 and there are three blades 2100. It is to be noted that not only more blades may be used, but that a plurality of alternating movements may also be determined for each one of them, which may allow a continuous ignition.

Figure VIII f a) illustrates the starting position of the six gears, the gears y1, y2 and z1, z2 being the closest, in pairs, one from the other (Arrow 51), while the gears x1, x2 are at their outmost position in the system in relation to the centre. In such a configuration, the centres of all gears are positioned at an equal distance in such a way that for each of them, a cam thereof founds itself in a closed state at the same position in the system, which will be referred to as the point A). For each gear, the system will therefore be made to rotate in such a way that the central axis of the gear be in front of this point A). Then, the gear will be inserted so as to remain always in the same state, either closed or more opened. Then the system will be rotated to the next gear, and it will be coupled to the supporting gear, so that the cam is in the very position selected before. The six gears will be acted on in this same way.

Each gear and cam will found itself in he position of the next on in row at every one ⅙ of rotation. Two gears will always found themselves facing each other while the complementary gears will be either in an output phase or in an input phase. Between these positions, two gears will be inversely in their most outbound position while the complementary gears will be going out and going in by twos.

In Figure VIII f, the gears are shown at a time between two explosions, the system having rotated by 1/12 rotation since the first illustration. Once again, it should be noted that in this embodiment, the specific position of the cams allows an improved angle of attack on the dynamical blade since the stopping blade will have arrived earlier into its blocking position. Therefore, no compression loss due to a delay or a distance between the blades may decrease the energy of such a system. This differentiation of the speeds allows the alternating getting apart and coming close of the pieces. Moreover, this differentiation in the torque ratios of the two complementary cams generates is here responsible for the differential force of the engine.

Figure IX f show how to draw inspiration from the latter data to apply these teachings to a system comprising two blades and four gears. By a method involving an initial layout of the gears, an effect similar to the previous one will be achieved using as few as four gears. Such a way of doing may prove very convenient especially in cases when room is too scarce for accommodating a high number of blades, and if it is desired to reduce the number of explosions.

Instead of aiming at placing opposite cams in their closest or more remote position, the method aims at placing the consecutive cams, successively in a closest position and in a more remote position, as selected. Therefore, in a first step, a cam number B is placed in its closest position (Arrow 51) relative a cam number A, the cams being thus positioned parallel in relation to two complementary induction rods (See distance d). Then the system will be moved by ⅛ 53 towards the right until the cam C gets aligned in a horizontal position. Then the gear D will be introduced by placing, as previously, the cam into its closest position from the preceding cam (Arrow 51). In so far as the speed of the engine is high enough, it may be assumed, as in real turbines, that such a technique will allow a continuous ignition. By using two assemblies, the system nay be supercharged into behaving like a turbine, but in this case in a closed way, thereby more economically.

Figure X f show eight main phases of this system. It will be noticed that for each coming close, the blocking and the dynamical thrust are maximum, and that the coming close of the cams always occurs ⅛ cycle (position 46) before the next one, in direction opposite that of the movement of the pieces. Igniter plugs may be positioned at each places of closest approach of the blades.

Figure XI f that the overall rotation of the system may be cancelled in such a way that the closest positions of the blades always occur at the same locations. Indeed, the passageway of the crankshaft may be Y-cutted 6000 so that the crankshaft may act on the supporting gear by means of a reduction gear rotataly located in the body. Obviously, this is made possible by rotataly mounting (Arrow 65) the supporting gear inside the side of the engine 20. Due to its speed (Arrow 63), this gear will make up for the recoil of the system and will allow that the cams always close at the same place.

Figure XII f shows how the induction cams may be forced to separate and get apart from one another, by using specific cross-shaped or cloverleaf-shaped cams 7200.

Figure XIII f shows how to improve the stop angle (7500) and the dynamical angle (7400) by tilting the sliding joint of the blades by a few degrees 7300. Moreover, this Figure shows that a specific pad 7600 having a flat external shape 7700 may be used to cushion the detonation force on the blade.

Figure XIV f show a how the sliding joints may be differently provided on each blade. This time, instead of being rotataly mounted at the centre and slidingly mounted to the cam, they are slidingly mounted at the centre and rotataly mounted to the cam. The cylinder may not be round-shaped anymore 19, and an eight shape is, for example here, is recovered. The interaction between the blades is still differential. The resulting shape reminds that of an eight. The shape of the cylinder may be made rectangular. So to speak, by adding on each blade extremity a pad, which will accentuate the turning movement in the corners. Here, shapes that are more fluid are preferred. In Figure XIV f b, the blades rather stand towards the centre, engaged slidingly one to the other, which slightly modifies the shape of an eight that will be obtained.

It will be noticed that by fastening the right hand loose piece to the end of the blade, the cylinder will have a shaped of an eight more pronounced, which tends to that of a rectangle.

In Figure XV f, the connecting points of the blade are modified and now involve one of the two cams. Here, each blade will be rotataly connected to one of the two cams 9200 and in a sliding way to the complementary cam 9300. The force generated in such a configuration will also be differential in nature, but the shape of the cylinder will be doomed differently. Once again, the differential action will be maintained, but the dynamical point of the blade will be increased by a lever effect.

Figure XVI f shows more precisely a thrust obtained due to complementary stops (Arrow 29) and dynamical actions (30), this time by using internal gears as supporting gears. Once again, the force generated by the system is increased since forces necessary for blocking are reduced while dynamical forces are increased. Indeed, the blocking forces are decreased whereas dynamical ones are increased by a lever effect.

Figure XVII f illustrates a simplified embodiment of the invention, wherein only one of the blades is active, the other one being rigidly related to a crankshaft 1020. In this case, one of the blades is connected to the induction gear by a cam thereof and related to the other blade by a connecting rod 1100, at a point either below or above the first connecting point 10100, in such a way as to generate a differential force.

Figure XVIII f shows a way to increase the differential feature of the previous one. As previously, the two blades are directly connected by a cam mechanism. However, here each blade is fitted with an induction gear and a cam, but here the cams are of different size (see Arrows 105a and 105b). Therefore the action of the gear is increased on one of the two blades, which creates an increased differential effect. However it is to be noted that what is generated on the side of one blade is lost on the opposite side that will waste energy instead of gaining some. These chambers will be maintained only for the purpose of admission or suction of the gases. The used gases, assuming an anti-discharge engine, will be suctioned by the joining blade instead of by the opposite blade, which allows building a clean engine, even with two blades. It may also be contemplated, in more elaborate embodiments, to use pairs of induction gears of different sizes to drive blades into an alternating movement twice as fast as their complementary blades, and therefore able to act as stop blades every second cycle since they require more energy, while otherwise only serving as spilling means. Even in this case, the turbine will operate due to the differential thrust in a very smooth way, while being well supported on its centre.

Figure XIX f shows how to partition the blades to allow an anti-discharge version of the engine, this time produced by partitions or step-like design. Such a step-like design may also be used to allow, in a given engine, an increment in the power. Indeed, each step may be provided with its own carburetion and ignition, and depending on the requirements of the engine, only the smaller ones may be sued, or only the larger ones, or otherwise both at the same time. Anti-discharge engines may also be built by assembling together two assemblies They may also be built by transversally separating and partitioning the blades, each blade being able, at a given time, to be in conjunction with the other.

Figure XX f shows how the gases circulate in a standard two-step version of the engine having two blades. The admission, compression of new gases, and spilling, filling up and compression to combustion, may be seen.

Although the present invention has been described hereinabove by way of specific embodiments thereof, it can be modified, without departing from the spirit and nature of the subject invention as defined in the appended claims.

What is claimed is:

1. A poly-inductive rotative machine comprising a compressive member, wherein induction of said compressive member is achieved by a mechanism realizing a positive induction on both a front and a back surface thereof, said mechanism being selected in the group consisting of a semi-transmission, a double semi-transmission, a side transmission, a pivot gear assembly, a poly-induction cam assembly, a poly-induction connecting rod assembly and a poly-induction sliding coupling assembly.

2. The poly-inductive machine of claim 1, comprising:
a cylinder in a body of said machine;
a blade having an induction gear of an external type rigidly mounted thereto;
a crankshaft fitted with a connecting rod, said blade being mounted on said connecting rod; and
a supporting gear of the external type rigidly fastened to a side of the body of the machine;
wherein said supporting gear is coupled to said induction gear of the blade by a gear of an internal type.

3. The poly-inductive machine of claim 1, wherein the compressive member is a blade and the semi-transmission comprises:
a body of the machine, provided with a supporting gear;
a cylinder, rigidly mounted in said body;
the blade, provided with a fixed blade induction gear coupled to said supporting gear of the machine;
a central axis of the machine, on which a supporting blade gear and a semi-transmissive axis gear are mounted; and
an eccentric, rotataly mounted around said central axis, and provided with an eccentric member fitted with a semi-transmissive driving gear;
wherein a linking gear, mounted in a side of said semi-transmission, couples said semi-transmissive driving gear of the eccentric, said semi-transmissive axis gear of the central axis and said supporting gears.

4. The poly-inductive machine as defined in claim 3, said semi-transmission being accelerative and inversive.

5. The poly-inductive of claim 3, driven by one of an axis of said eccentric, said central axis and an axis of said linking gear, mounted in a side of said semi-transmission.

6. The poly-inductive of claim 3, wherein two connecting rods connect connecting rod journals of a crankshaft and opposite connecting points of the blade for a double semi-transmission.

7. The poly-inductive machine as defined in claim 3, using standard gears selected in of internal and external gears.

8. The poly-inductive of claim 7, said side transmission comprising:
a cylinder mounted in a body of the machine;
an eccentric rigidly mounted on a central axis of the machine, said eccentric rotately fitted with a rotation axis of side semi-transmission gears, and rotately supporting a blade, said blade provided with an internal type induction gear coupled to said side semi-transmission gears;
a supporting gear rigidly fixed to said body; and
a side semi-transmission axis rotately mounted in said eccentric; said side semi-transmission gears being connected to said side semi-transmission axis;
wherein a first one of said side semi-transmission gears is coupled to said supporting gear and a second one of said side semi-transmission gears is coupled to said an internal type induction gear of the blade.

9. The poly-inductive machine of claim 3, wherein said supporting and semi-transmissive gears are of the internal type and said linking gear is of the external type.

10. The poly-inductive machine of claim 3, wherein said blade has a number of sides inferior by one to a number of sides of said cylinder.

11. The poly-inductive machine of claim 3, wherein said blade has a number of sides superior by one to a number of sides of said cylinder.

12. The poly-inductive machine of claim 1, said compressive member comprising a plurality of blades, said compressive member being supported by a mechanical assembly comprising secondary crankshafts and a master crankshaft.

13. The poly-inductive machine of claim 1, a cylinder thereof and said compressive member having a circular movement, the positive induction being distributed on two indirectly connected blades, said blades being connected to poly-induction mechanisms.

14. The poly-inductive machine of claim 1, using at least one secondary crankshaft having a shape of an eccentric with a passageway allowing engaging connecting rods of at least one master crankshaft.

15. The poly-inductive machine of claim 14, said compressive member having a rectilinear action.
